(19) United States
(12) Patent Application Publication
(10) Pub. No.: US 2015/0036276 A1
(43) Pub. Date: Feb. 5, 2015

(54) TRANSPARENT CONDUCTIVE FILM, CONDUCTIVE ELEMENT, COMPOSITION, COLORED SELF-ASSEMBLED MATERIAL, INPUT DEVICE, DISPLAY DEVICE, AND ELECTRONIC INSTRUMENT

(71) Applicant: DEXERIALS CORPORATION, Tokyo (JP)

(72) Inventors: Naoto Kaneko, Sendai-shi (JP); Mikihisa Mizuno, Sendai-shi (JP); Sung-kil Lee, Utsunomiya-shi (JP); Ryosuke Iwata, Utsunomiya-shi (JP); Yasuhisa Ishii, Utsunomiya-shi (JP)

(21) Appl. No.: 14/382,288

(22) PCT Filed: Mar. 5, 2013
(86) PCT No.: PCT/JP2013/056026

§ 371 Date: Aug. 29, 2014

(30) Foreign Application Priority Data
Mar. 6, 2012 (JP) 2012-049860

(51) Int. Cl. G02B 1/04; G02B 5/23; G06F 1/16

(52) U.S. Cl. CPC G02B 1/04; G06F 1/1637; G02B 5/23
USPC 361/679.21; 428/328; 252/514

(57) ABSTRACT

A transparent conductive film includes a metal filler and a colored self-assembled material adsorbed to the surface of the metal filler. This transparent conductive film can prevent diffuse reflection of light on the surface of the metal filler.

### TECHNICAL FIELD

The present technique relates to a transparent conductive film, a conductive element, a composition, a colored self-assembled material, an input device, a display device, and an electronic instrument, and more particularly to a transparent conductive film including a metal filler.

### BACKGROUND ART

Metal oxides such as indium tin oxide (ITO) have been used in transparent conductive films, which require optical transparency, such as transparent conductive films provided on the display screen of a display panel, particularly transparent conductive films of information input devices disposed on the display screen side of a display panel. However, transparent conductive films using a metal oxide have been expensive to produce because of sputter deposition under vacuum environment and easy to cause cracking and separation by deformation such as bending and deflection.

Therefore, transparent conductive films including a metal filler have been studied which can substitute transparent conductive films including a metal oxide and which enable film formation by coating or printing and further have high resistance against bending and deflection. Transparent conductive films including a metal filler have attracted attention as next-generation transparent conductive films free of indium, which is a rare metal (for example, see Patent Literatures 1 and 2, and Non-Patent Literature 1).

However, when a transparent conductive film including a metal filler is provided on the display screen side of a display panel, diffuse reflection of outside light occurs on the surface of the metal filler, so that black display of the display panel slightly becomes bright, which is called a milky appearance (whitish appearance). The milky appearance (whitish appearance) can be responsible for decrease in contrast of display contents and deterioration of display characteristics.

Patent Literature 3 has described a technique for reducing diffuse reflection of light on the surface of a metal nanotube by metal plating of a metal wire and subsequent etching of the metal wire to form the metal nanotube (hollow nano structure). Patent Literature 3 has also described another technique for reducing diffuse reflection of light on the surface of a metal nanotube by plating and subsequent oxidization of a metal nanowire to make the surface darken or blacken.

Patent Literature 2 has described a technique for preventing light scattering by combined use of a metal nanowire and a secondary conductive medium (carbon nanotube (CNT), conductive polymer, ITO, etc.)

### CITATION LIST

### Patent Literature

Patent Literature 1: Japanese Translation of PCT Patent Application Publication No. 2010-507199
Patent Literature 2: Japanese Translation of PCT Patent Application Publication No. 2010-525526
Patent Literature 3: Japanese Translation of PCT Patent Application Publication No. 2010-525527

### Non-Patent Literature

Non-Patent Literature 1: “ACS Nano” 2010, Vol. 4, No. 5, pp. 2955-2963

### SUMMARY OF INVENTION

### Technical Problem

Accordingly, it is an object of the present technique to provide a transparent conductive film, a conductive element, a composition, a colored self-assembled material, an input device, a display device, and an electronic instrument which prevent diffuse reflection of light on the surface of a metal filler.

### Solution to Problem

In order to solve the aforementioned problems, a first technique is a transparent conductive film including:

a metal filler; and

a colored self-assembled material provided on the surface of the metal filler.

A second technique is a composition including

a metal filler, and

a colored self-assembled material provided on the surface of the metal filler; a transparent conductive film-forming composition including a metal filler to which a colored self-assembled material is adsorbed and a photosensitive resin; or a transparent conductive film-forming composition including a metal filler, a colored self-assembled material, and a photosensitive resin.

A third technique is a conductive element including:

a substrate; and

a transparent conductive film provided on the surface of the substrate,

wherein the transparent conductive film includes:

a metal filler; and

a colored self-assembled material provided on a surface of the metal filler.

A fourth technique is an input device including:

a substrate; and

a transparent conductive film provided on the surface of the substrate,

wherein the transparent conductive film includes:

a metal filler; and

a colored self-assembled material provided on the surface of the metal filler.

A fifth technique is a display device including:

a display unit; and

an input device provided in the display unit or on the surface of the display unit,

wherein the input device includes a substrate and a transparent conductive film provided on the surface of the substrate, and

the transparent conductive film includes:

a metal filler; and

a colored self-assembled material provided on the surface of the metal filler.

A sixth technique is an electronic instrument including:

a display unit; and

an input device provided in the display unit or on the surface of the display unit,

wherein the input device includes a substrate and a transparent conductive film provided on the surface of the substrate, and

the transparent conductive film includes:

a metal filler; and

a colored self-assembled material provided on the surface of the metal filler.

In the present technique, the colored self-assembled material is provided on the surface of the metal filler, so that the colored self-assembled material can absorb light incident on the surface of the metal filler. Therefore, this can prevent diffuse reflection of light on the surface of the metal filler.

### Advantageous Effects of Invention

As described above, the present technique can prevent diffuse reflection of light on the surface of the metal filler while suppressing an increase in resistance of the transparent conductive film.

### BRIEF DESCRIPTION OF DRAWINGS

FIG. 1 includes a cross-sectional diagram (A) illustrating an example of a configuration of a transparent conductive element according to a first embodiment of the present technique, and a schematic diagram (B) illustrating an enlarged surface of the metal filler contained in the transparent conductive film.

FIG. 2 includes cross-sectional diagrams (A, B, and C) illustrating modifications of the transparent conductive element of the first embodiment of the present technique.

FIG. 3 includes cross-sectional diagrams (A, B, and C) illustrating modifications of the transparent conductive element of the first embodiment of the present technique.

FIG. 4 includes cross-sectional diagrams (A and B) illustrating modifications of the transparent conductive element of the first embodiment of the present technique.

FIG. 5-1 includes a cross-sectional diagram (A) illustrating an example of a configuration of a transparent conductive element according to a second embodiment of the present technique, and cross-sectional diagrams (B) and (c) illustrating modifications thereof.

FIG. 5-2 is a chart of the production process of the transparent conductive element according to the second embodiment of the present technique.

FIG. 5-3 is a chart of the production process of the transparent conductive element according to a modification of the second embodiment of the present technique.

FIG. 5-4 is a chart of the production process of the transparent conductive element according to a modification of the second embodiment of the present technique.

FIG. 6 includes schematic diagrams (A, B, and C) for describing the process of treating the surface with the colored self-assembled material.

FIG. 7 includes schematic diagrams (A and B) for describing the process of treating the surface with the colored self-assembled material.

FIG. 8 includes schematic diagrams (A and B) for describing the process of treating the surface with the colored self-assembled material.

FIG. 9 includes a cross-sectional diagram (A) illustrating an example of a configuration of an information input device according to a fifth embodiment of the present technique, and a perspective view (B) thereof.

FIG. 10 includes cross-sectional diagrams (A and B) illustrating modifications of the information input device according to the fifth embodiment of the present technique.

FIG. 11 includes cross-sectional diagrams (A and B) illustrating modifications of the information input device according to the fifth embodiment of the present technique.

FIG. 12 is a cross-sectional diagram illustrating an example of a configuration of a display device according to a sixth embodiment of the present technique.

FIG. 13 is a perspective view of an appearance of a television set according to a seventh embodiment of the present technique.

FIG. 14 includes perspective views (A and B) of an appearance of a digital camera according to the seventh embodiment of the present technique.

FIG. 15 is a perspective view of an appearance of a laptop personal computer according to the seventh embodiment of the present technique.

FIG. 16 is a perspective view of an appearance of a video camera including the display unit according to the seventh embodiment of the present technique.

FIG. 17 is a front view of an appearance of a mobile terminal including the display unit according to the seventh embodiment of the present technique.

FIG. 18 is a plan view of a photomask used in Example 11.

FIG. 19-1 is an optical micrograph (at 100×) of Example 11.

FIG. 19-2 is an optical micrograph (at 500×) of Example 11.

### DESCRIPTION OF EMBODIMENTS

### Summary

The present inventors have intensively studied to solve the aforementioned problems. The intensive studies will be summarized below. As described above, transparent conductive electrodes including a metal filler have problems of lowered contrast of a display panel or visible patterns in patterning because metallic luster of the metal filler increases the brightness caused by reflection of light.

As a result of intensive studies to solve these problems, the present inventors have found the technique of reducing visible patterns in patterning by treating the surface of a metal filler with a colored compound to decrease the reflectance L value (i.e., L value of the L*a*b*color system, obtained from measurement of spectral reflectance.)

However, the present inventors have further studied the present technique and as a result, found that the present technique disadvantageously increases the sheet resistance although it can decrease the reflectance L value to reduce visible patterns in patterning.

As a result of intensive studies to solve this problem, the present inventors have found the technique of reducing an increase in the sheet resistance after the treatment of the surface with a colored compound by applying thiols and/or sulfides to the surface of a metal filler. The present inventors have further studied the present technique and found the technique of treating the surface of a metal filler with a colored self-assembled material as a technique capable of further suppressing an increase in the sheet resistance.

### EMBODIMENTS

Embodiments of the present technique will be described in the following order with reference to the drawings:

1. First embodiment (Example of configuration of transparent conductive element);
2. Second embodiment (Example of configuration of transparent conductive element having patterned transparent conductive film);
3. Third embodiment (Method of producing transparent conductive film, involving treatment of surface of metal filler with colored self-assembled material after film formation of dispersion containing metal filler);
4. Fourth embodiment (Method of producing transparent conductive film, involving film formation of dispersion containing metal filler after treatment of surface of metal filler with colored self-assembled material);
5. Fifth embodiment (Example of configuration of information input device and display device);
6. Sixth embodiment (Example of configuration of display device); and
7. Seventh embodiment (Example of configuration of electronic instrument)

### 1. First Embodiment

### Configuration of Transparent Conductive Element

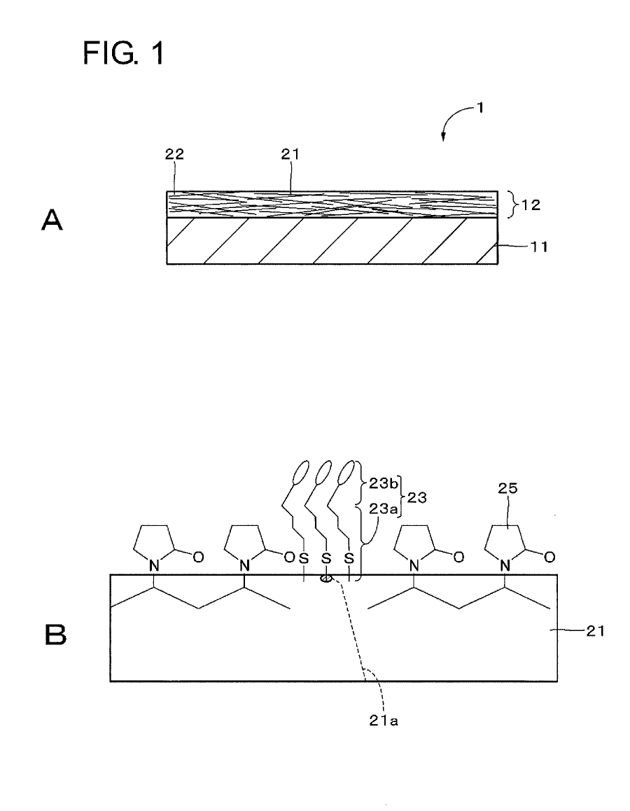

The cross-sectional diagram A of FIG. 1 illustrates an example of a configuration of a transparent conductive element according to a first embodiment of the present technique. A transparent conductive element 1 includes a substrate 11 and a transparent conductive film 12 provided on the surface of the substrate 11.

### (Substrate)

The substrate 11 is, for example, a transparent inorganic substrate or a transparent plastic substrate. The substrate 11 can be, for example, film-shaped, sheet-shaped, plate-shaped, block-shaped, or the like. Examples of the materials of the inorganic substrate may include quartz, sapphire, and glass. As materials of the plastic substrate, for example, known polymer materials can be used. Specific examples of the known polymer materials may include triacetyl cellulose (TAC), polyester (TPEE), polyethylene terephthalate (PET), polyethylenenaphthalate (PEN), polyimide (PI), polyamide (PA), aramid, polyethylene (PE), polyacrylate, polyethersulfone, polysulfone, polypropylene (PP), diacetyl cellulose, polyvinyl chloride, acrylic resin (PMMA), polycarbonate (PC), epoxy resin, urea resin, urethane resin, melamine resin, and cycloolefin polymer (COP). Although the thickness of the substrate 11 can be selected, for example, within 5 μm to 5 mm, the thickness of the substrate 11 is not particularly limited and can be freely selected in consideration of light transmittance and moisture vapor transmission rate.

(Transparent Conductive Film) The reflectance L value of the transparent conductive film 12 is preferably 8.5 or less, and more preferably 8 or less. This improves the milky appearance (whitish appearance) and allows the transparent conductive film 12 and the transparent conductive element 1 to be favorably disposed at the display screen side of a display device. It is noted that the reflectance L value can be controlled by the amount of a colored self-assembled material adsorbed to a metal filler 21.

The transparent conductive film 12 contains the metal filler 21, a resin material 22, and the colored self-assembled material (colored self-assembled compound). The transparent conductive film 12 may further include optional additives such as a dispersant, a thickener, and a surfactant, as components other than the above components.

The schematic diagram B of FIG. 1 illustrates an enlarged surface of the metal filler 21 contained in the transparent conductive film 12. The surface of the metal filler 21 is modified with the colored self-assembled material (colored modification material) 23. In the transparent conductive element 1 in the schematic diagram B of FIG. 1, the surface of the metal filler 21 is further modified with a dispersant 25.

The modification of the surface of the metal filler 21 with the colored self-assembled material 23 allows light incident on the surface of the metal filler 21 to be absorbed by the colored self-assembled material 23. Therefore, this modification can prevent diffuse reflection of light on the surface of the metal filler 21. This modification can also prevent an increase in the resistance of the transparent conductive film 12 as compared with modification of the surface of the metal filler 21 with colored compounds such as dyes.

The dispersant 25 which modifies the surface of the metal filler 21 is adsorbed to the metal filler 21 to prevent aggregation of the metal fillers 21 in the dispersion forming the transparent conductive film 12, and to improve the dispersibility of the metal filler 21 in the transparent conductive film 12.

The dispersion containing the metal filler 21 will be described below in detail.

### (Metal Filler)

The metal filler 21 contains a metal material as a main component. As the metal material, for example, at least one selected from the group consisting of Ag, Au, Ni, Cu, Pd, Pt, Rh, Ir, Ru, Os, Fe, Co, and Sn can be used.

Examples of the shape of the metal filler 21 may include, but are not particularly limited to, a spherical shape, an ellipsoid shape, a needle shape, a plate shape, a flake shape, a tubular shape, a fiber shape, a bar shape (rod shape), and indefinite shapes. In this case, the fiber shape includes those made of complex materials. The fiber shape may also include a wire shape. Hereinafter, a wire-shaped metal filler is referred to as a “metal wire.”

It is noted that two or more metal fillers 21 having the above shapes may be used in combination. In this case, the spherical shape includes not only an exact spherical shape but also substantially spherical shapes such as flat spherical shapes and distorted spherical shapes. The ellipsoid shapes include not only an exact ellipsoid shape but also substantially ellipsoid shapes such as flat ellipsoid shapes and distorted ellipsoid shapes.

The metal filler 21 is, for example, a fine metal nanowire having a diameter of nm order. When the metal filler 21 is a metal wire, for example, a preferred shape of the metal wire is such that the average minor axis diameter (average diameter of the wire) is more than 1 nm and 500 nm or less and the average major axis length is more than 1 μm and 1000 μm or less. The average major axis length of the metal wire is more preferably 5 μm or more and 50 μm or less. The average minor axis diameter of 1 nm or less deteriorates the conductivity of the metal wire to decrease the function as a conductive film after coating. In contrast, the average minor axis diameter of more than 500 nm deteriorates the total light transmittance of the transparent conductive film 12. In addition, the average major axis length of 1 μm or less causes a difficulty of connection between metal wires to decrease the function of the transparent conductive film 12 as a conductive film. In contrast, the average major axis length of more than 1000 μm tends to deteriorate the total light transmittance of the transparent conductive film 12 and also tends to deteriorate the dispersibility of the metal wire in the dispersion which is used for forming the transparent conductive film 12. The average major axis length of the metal wire of 5 μm or more and 50 μm or less improves the conductivity of the transparent conductive film 12 and also reduces occurrence of short circuits during patterning of the transparent conductive film 12. Furthermore, the metal filler 21 may have a wire shape where metal nanoparticle are connected like a string of beads. In this case, the length is not limited.

The basis weight of the metal filler 21 is preferably from 0.001 to 1.000 [g/m²]. When the basis weight of the metal filler 21 is less than 0.001 [g/m²], the amount of the metal filler 21 is insufficient in the transparent conductive film 12 to deteriorate the conductivity of the transparent conductive film 12. In contrast, a larger basis weight of the metal filler 21 results in a lower sheet resistance value, but the basis weight of the metal filler 21 of more than 1.000 [g/m²] deteriorates the total light transmittance of the transparent conductive film 12.

### (Resin Material)

The resin material 22 is a so-called binder material. The metal filler 21 is dispersed in the cured resin material 22 in the transparent conductive film 12. The resin material 22 used herein can be widely selected from known transparent naturally-occurring polymer resins and synthetic polymer resins, and may be a thermoplastic resin, a thermosetting resin, or a photocurable resin. Examples of the thermoplastic resin may include polyvinyl chloride, a vinyl chloride-vinyl acetate copolymer, polymethyl methacrylate, cellulose nitrate, chlorinated polyethylene, chlorinated polypropylene, vinylidene fluoride, ethyl cellulose, and hydroxypropyl methylcellulose. Examples of the thermo(photo)setting resin, which is cured by heat, light, electron rays, and radioactive rays, may include melamine acrylate, urethane acrylate, isocyanate, epoxy resins, polyimide resins, and silicon resins such as acrylic modified silicate.

Furthermore, photosensitive resins can be used as the resin material 22. Photosensitive resins are resins which are chemically changed by irradiation of light, electron rays, or radioactive rays to change the solubility in a solvent. The photosensitive resin can be a positive type (exposed areas are dissolved in a developer) or a negative type (exposed areas are undissolved in a developer). The use of the photosensitive resin as the resin material 22 can reduce the number of steps during the patterning of the transparent conductive film 12 by etching as described below.

As the positive photosensitive resin, known positive photoresist materials can be used. Examples of the positive photoresist material may include compositions containing naphthoquinonediazide compounds and polymers (novolac resins, acrylic copolymer resins, hydroxypolyamide, and the like). As the negative photosensitive material, known negative photoresist materials can be used. Examples of the negative photoresist material may include: compositions containing cross-linking agents (bisazide compounds, hexamethoxy methylmelamine, tetramethoxy glycoluril, and the like) and polymers (polyvinyl alcohol-based polymer, polyvinyl butyral-based polymer, polyvinylpyrrolidone-based polymer, polyacrylamide-based polymer, polyvinyl acetate-based polymer, polyoxyalkylene-based polymer, and the like); polymers to which photosensitive groups (an azido group, a phenyl azido group, a quinone azido group, a stilbene group, a chalcone group, a diazonium salt group, a cinnamic acid group, an acrylic acid group, and the like) are introduced (polyvinyl alcohol-based polymer, polyvinyl butyral-based polymer, polyvinylpyrrolidone-based polymer, polyacrylamide-based polymer, polyvinyl acetate-based polymer, polyoxyalkylene-based polymer, and the like); and compositions containing photopolymerization initiators and at least one of (meth)acrylic monomers and (meth)acrylic oligomers. Examples of commercial products may include BIOSURFINE-AWP produced by Toyo Gosei Co., Ltd as a polymer to which a photosensitive group is introduced.

To the resin material 22, a surfactant, a viscosity modifier, a dispersant, a curing-accelerating catalyst, a plasticizer, and further stabilizers such as an antioxidant and a sulfuration inhibitor may be optionally added as additives.

### (Colored Self-Assembled Material)

The colored self-assembled material 23 is adsorbed to the surface of the metal filler 21 in the transparent conductive film 12. The phrase “being adsorbed” here means the phenomenon in which the colored self-assembled material 23 is present on the surface of the metal filler 21, or on and near the surface of the metal filler 21. The adsorption includes chemical adsorption and physical adsorption, but preferably chemical adsorption from the viewpoint of large adsorbability. Both of the chemically-adsorbed, colored self-assembled material and the physically-adsorbed, self-assembled material may be present on the surface of the metal filler 21. The chemical adsorption means the adsorption of the colored self-assembled material 23 to the surface of the metal filler 21 through chemical bonds such as a covalent bond, an ionic bond, a coordinate bond, and a hydrogen bond. The physical adsorption is caused by van der Waals force. The adsorption may be electrostatic.

As the colored self-assembled material 23, for example, combination of a colored or colorless self-assembled material 23a and a colored material 23b (schematic diagram B in FIG. 1), and an intrinsically-colored self-assembled material without being bound to a colored material 23b can be used. The colored self-assembled material 23 has, for example, at a terminal, a chromophore which absorbs light in the visible light range.

The colored self-assembled material 23 preferably forms a colored self-assembled monolayer (SAM) on the surface of the metal filler 21. This can prevent decrease in transparency to visible light. In addition, this can also minimize the amount of the colored self-assembled material 23 to be used.

It is preferred that the colored self-assembled material 23 be localized on the surface of the metal filler 21. This can prevent decrease in transparency to visible light. In addition, this can also minimize the amount of the colored self-assembled material 23 to be used.

The colored self-assembled material 23 has the ability to absorb light in the visible light range. The visible light range means a wavelength band region of about 360 nm or more and 830 nm or less.

The modification of the surface of the metal filler 21 with the colored self-assembled material 23 can be confirmed in the following manner. First, the transparent conductive film 12 including the metal filler 21 as a target to be confirmed is immersed in a solution capable of etching a known metal for about several to ten or so hours to extract the metal filler 21 and compounds which modify the surface of the metal filler 21. Next, a solvent is removed from an extract by heating or reduced pressure to concentrate extracted components. At this time, separation by chromatography may be optionally carried out. Next, the concentrated extracted components described above are analyzed by gas chromatography (GC) to check molecules of the modifying compounds and fragments thereof, thereby determining the presence or absence of the modifying compounds. The use of a deuterated solvent for extraction of the modifying compound allows the modifying compound or fragments thereof to be identified by NMR analysis.

### (Colored Self-Assembled Material)

As the self-assembled material 23a forming the colored self-assembled material 23, for example, one or more compounds selected from the group consisting of thiols, dithiols, sulfides, and disulfides, preferably compounds having a thiol group, a dithiol group, a sulfide group, or a disulfide group at one end and a functional group to be bound to the colored material 23b at the other end can be used. The self-assembled material 23a, however, is not limited to these as long as being capable of forming a self-assembled film on the metal filler 21.

### (Thiols and Dithiols)

Thiols, for example, contain at least a thiol group, and a straight, branched, or cyclic hydrocarbon group. Thiols may be compounds containing one thiol group, dithiol compounds containing two thiol groups, or compounds containing three or more thiol groups. The hydrocarbon group may be saturated or unsaturated. Some hydrogen atoms in the hydrocarbon group may be substituted by a hydroxyl group, an amino group, a carboxyl group, a halogen atom, an alkoxysilyl group, or the like.

More specific examples of thiols may include 2-aminoethane thiol, 2-aminoethanethiol hydrochloride, 1-propanethiol, 3-mercaptopropionic acid, (3-mercaptopropyl)trimethoxysilane, 1-butanethiol, 2-butanethiol, isobutylmercaptan, isoamylmercaptan, cyclopentanethiol, 1-hexanethiol, cyclohexanethiol, 6-hydroxy-1-hexanethiol, 6-amino-1-hexanethiol hydrochloride, 1-heptanethiol, 7-carboxy-1-heptanethiol, 7-amido-1-heptanethiol, 1-octanethiol, tert-octanethiol, 8-hydroxy-1-octanethiol, 8-amino-1-octanethiol hydrochloride, 1H,1H,2H,2H-perfluorooctanethiol, 1-nonanethiol, 1-decanethiol, 10-carboxy-1-decanethiol, 10-amido-1-decanethiol, 1-naphthalenethiol, 2-naphthalenethiol, 1-undecanethiol, 11-amino-1-undecanethiol hydrochloride, 11-hydroxy-1-undecanethiol, 1-dodecanethiol, 1-tetradecanethiol, 1-hexadecanethiol, 16-hydroxy-1-hexadecanethiol, 16-amino-1-hexadecanethiol hydrochloride, and 1-octadecanethiol. These thiols may be used singly or in any combination of two or more types thereof.

Examples of dithiols may include 1,2-ethanedithiol, 1,3-propanedithiol, 1,4-butanedithiol, 2,3-butanedithiol, 2,2′-thiodiethanethiol, 1,5-pentanedithiol, toluene-3,4-dithiol, 1,2-benzenedithiol, 1,3-benzenedithiol, 1,3-benzenedimethanethiol, 1,4-benzenedithiol, 1,6-hexanedithiol, 5-bromo-1,3-benzenedithiol, biphenyl-4,4-dithiol, 1,4-benzenedimethanethiol, 4,4′-dimercaptostilbene, 4,4′-bis(mercaptomethyl)biphenyl, 1,2-benzenedimethanethiol, 1,3-benzenedimethanethiol, benzene-1,3-dithiol, p-terphenyl-4,4″-dithiol, 2,3-dimercapto-1-propanol, meso-2,3-dimercaptosuccinic acid, bis(2-mercaptoethyl)ether, and 1,16-hexadecanedithiol.

Thiols may be trithiols such as 1,3,5-benzenetrithiol, trimethylolpropane tris(3-mercaptopropionate), or tetrathiols such as pentaerythritol tetrakis(3-mercaptopropionate).

These thiols may be used singly or in any combination of two or more types thereof.

### (Sulfides)

Sulfides, for example, contain at least a sulfide group, and a straight, branched, or cyclic hydrocarbon group. Sulfides may contain two or more sulfide groups. Some hydrogen atoms in the hydrocarbon group may be substituted by a hydroxyl group, an amino group, a carboxyl group, a halogen atom, an alkoxysilyl group, or the like.

More specific examples of sulfides may include propylsulfide, furfurylsulfide, hexylsulfide, phenylsulfide, phenyl trifluoromethyl sulfide, bis(4-hydroxyphenyl)sulfide, heptylsulfide, octylsulfide, nonylsulfide, decylsulfide, dodecylmethylsulfide, dodecylsulfide, tetradecylsulfide, hexadecylsulfide, and octadecylsulfide. These sulfides may be used singly or in any combination of two or more types thereof.

### (Disulfides)

Disulfides, for example, contain at least a disulfide group, and a straight, branched, or cyclic hydrocarbon group. Disulfides may contain two or more disulfide groups. Some hydrogen atoms in the hydrocarbon group may be substituted by a hydroxyl group, an amino group, a carboxyl group, a halogen atom, an alkoxysilyl group, or the like.

Examples of disulfides may include 2-hydroxyethyl disulfide, propyldisulfide, isopropyldisulfide, 3-carboxypropyl disulfide, allyldisulfide, isobutyldisulfide, tert-butyldisulfide, amyldisulfide, isoamyldisulfide, 5-carboxypentyl disulfide, furfuryldisulfide, hexyldisulfide, cyclohexyldisulfide, phenyldisulfide, 4-aminophenyl disulfide, heptyldisulfide, 7-carboxyheptyl disulfide, benzyldisulfide, tert-octyldisulfide, decyldisulfide, 10-carboxydecyldisulfide, and hexadecyldisulfide. These disulfides may be used singly or in any combination of two or more types thereof.

### (Colored Material)

As the colored material 23b, acid halides synthesized from colored material precursors such as dyes are preferred. For example, the colored self-assembled material 23 can be obtained by binding one terminal functional group of the self-assembled material 23a to the functional group of the colored material 23b. Examples of the bond between these functional groups may include an amide bond (—CNO—) between a carboxyl group (—COOH) and an amine (—NH2). It is noted that the bond between these functional groups is not limited thereto as long as the colored self-assembled material 23 is obtained by the bond.

As the colored material 23b, for example, acid halides, particularly acid chlorides synthesized from colored material precursors (for example, dyes) having a carboxylic acid as a terminal functional group are preferred. The synthesis method of acid chlorides generally involves reacting a halogenating agent with carboxylic acid or its salts, esters, or acid anhydrides, or the like, but also includes oxidation of aldehydes and haloformylation of hydrocarbons (Experimental Chemistry 22, Organic Synthesis IV, Acids, Amino Acids, Peptides; Edited by The Chemical Society of Japan.)

The colored material 23b is, for example, represented by the following general formula (1).

R—COX, R—SO₃H, or R—SO₃⁻Na⁺ (1)

(wherein R is a chromophore absorbing light in the visible light range, COX is a functional group to be bound to the self-assembled material 23a, and X is fluorine (F), chlorine (Cl), bromine (Br), or iodine (I).)

Examples of the chromophore [R] may include chromophores [R2] of colored material precursors described below.

Examples of the halogenating agent may include thionyl chloride, oxalyl chloride, hydrogen chloride, chlorine, t-butyl hypochlorite, sulfuryl chloride, allyl chloride, benzyl chloride, phosphorus trichloride, phosphorus pentachloride, dichlorotriphenylphosphorane, triphenylphosphine, carbon tetrachloride, carbon tetrabromide, thionyl bromide, cyanuric fluoride, dialkylamino sulfur trifluoride, anhydrous hydrogen fluoride, dichloromethyl ether, dibromomethyl methyl ether, and 1-dimethylamino-1-chloro-2-methylpropene. It is noted that the halogenating agent is not limited to these as long as enabling halogenation. In addition, synthetic halogenating agents can also be used.

### (Colored Material Precursor)

The colored material precursor has chromophore R2 absorbing light in the visible light range. The colored material precursor is represented by the following general formula (2). The structure of the colored material precursor is not limited to the structure represented by this general formula. For example, the number of functional group X2 is not limited to one, and can be two or more.

R2-X2 (2)

(wherein R2 is a chromophore absorbing light in the visible light range, and X2 is a functional group which reacts with the halogenating agent to produce an acid halide.)

As the chromophore [R2] of the colored material precursor, an organic material or an inorganic material can be used.

The chromophore [R2] of the inorganic material can be bound to the functional group [X2] and can have an absorption wavelength range in the visible light range. Examples of chromophore [R2] may include carbon black.

The chromophore [R2] of the organic material is, for example, at least one selected from the group consisting of unsaturated alkyl groups, aromatic rings, heterocyclic rings, and metal complexes. Specific examples of the chromophore [R2] may include naphthoquinone derivatives, stilbene derivatives, indophenol derivatives, diphenylmethane derivatives, anthraquinone derivatives, triallylmethane derivatives, diazine derivatives, indigoid derivatives, xanthene derivatives, oxazine derivatives, phthalocyanine derivatives, acridine derivatives, and sulfur atom-containing compounds such as thiazine derivatives. These can have a nitroso group, a nitro group, an azo group, a methine group, an amino group, a ketone group, a thiazolyl group, and the like. The chromophore [R2] may contain a metal ion.

From the viewpoint of improvement in transparency of the transparent conductive film 12, at least one selected from compounds having a coloring structure, such as cyanines, quinones, ferrocenes, triphenylmethanes, and quinolines, and Cr complexes, Cu complexes, azo group-containing compounds, and indoline group-containing compounds is preferably used as the chromophore [R2].

Examples of the functional group [X2] of the colored material precursor include a sulfo group (including sulfonates), a sulfonyl group, a sulfonamide group, a carboxylic acid group (including carboxylates), and a phosphate group (including phosphoric acid salts and phosphoric acid esters). At least one functional group [X2] may be present in the colored material precursor. The functional group [X2] is preferably a carboxylic acid group, a phosphate group, or the like, more preferably a carboxylic acid group.

When the functional group [X2] contains, for example, N (nitrogen), S (sulfur), O (oxygen), or the like, the functional group [X2] may constitute a part of the chromophore [R2].

Examples of the colored material precursor described above may include dyes such as acid dyes and direct dyes. More specific examples of the dyes may include dyes having a sulfo group, such as Kayakalan Bordeaux BL, Kayakalan Brown GL, Kayakalan Gray BL 167, Kayakalan Yellow GL 143, Kayakalan Black 2RL, Kayakalan Black BGL, Kayakalan Orange RL, Kayarus Cupro Green G, Kayarus Supra Blue MRG, Kayarus Supra Scarlet BNL 200, which are produced by Nippon Kayaku Co., Ltd. and Lanyl Olive BG produced by Taoka Chemical Co., Ltd. Other colored material precursors include Kayalon Polyester Blue 2R-SF, Kayalon Microester Red AQ-LE, Kayalon Polyester Black ECX 300, and Kayalon Microester Blue AQ-LE, which are produced by Nippon Kayaku Co., Ltd. Examples of dyes having a carboxyl group may include dyes for dye-sensitized solar cells, specifically Ru complexes such as N3, N621, N712, N719, N749, N773, N790, N820, N823, N845, N886, N945, K9, K19, K23, K27, K29, K51, K60, K66, K69, K73, K77, Z235, Z316, Z907, Z907Na, Z910, Z991, CYC-B1, and HRS-1, organic dyes such as Anthocyanine, WMC234, WMC236, WMC239, WMC273, PPDCA, PTCA, BBAPDC, NKX-2311, NKX-2510, NKX-2553 (produced by Hayashibara Co., Ltd.), NKX-2554 (produced by Hayashibara Co., Ltd.), NKX-2569, NKX-2586, NKX-2587 (produced by Hayashibara Co., Ltd.), NKX-2677 (produced by Hayashibara Co., Ltd.), NKX-2697, NKX-2753, NKX-2883, NK-5958 (produced by Hayashibara Co., Ltd.), NK-2684 (produced by Hayashibara Co., Ltd.), Eosin Y, Mercurochrome, MK-2 (produced by Soken Chemical & Engineering Co., Ltd.), D77, D102 (produced by Mitsubishi Paper Mills, Ltd.), D120, D131 (produced by Mitsubishi Paper Mills, Ltd.), D149 (produced by Mitsubishi Paper Mills, Ltd.), D150, D190, D205 (produced by Mitsubishi Paper Mills, Ltd.), D358 (produced by Mitsubishi Paper Mills, Ltd.), JK-1, JK-2, JK-5, ZnTPP, H2TC1PP, H2TC4PP, phthalocyanine dyes (zinc phtalocyanine-2,9,16,23-tetra-carboxylic acid, 2-[2′-(zinc9′,16′,23′-tri-tert-butyl-29H,31H-phthalocyanyl)]succinic acid, polythiohene dye (TT-1), a pendant type polymer, and cyanine dyes (P3TTA, C1-D, SQ-3, B1).

Furthermore, colored compounds for use as pigments can also be used as the colored material precursor, and examples thereof may include Opera Red, Permanent Scarlet, Carmine, Violet, Lemon Yellow, Permanent Yellow Deep, Sky Blue, Permanent Green Light, Permanent Green Middle, Burnt Sienna, Yellow Ochre, Permanent Orange, Permanent Lemon, Permanent Red, Viridian (Hue), Cobalt Blue (Hue), Prussian Blue (Hue), Jet Black, Permanent Scarlet, and Violet, which are produced by TURNER COLOR WORKS LTD. For example, colored compounds produced by HOLBEIN WORKS, Ltd. can also be used, such as Bright Red, Cobalt Blue Hue, Ivory Black, Yellow Ochre, Permanent Green Light, Permanent Yellow Light, Burnt Sienna, Ultramarine Deep, Vermilion Hue, and Permanent Green. Of these colored compounds, Permanent Scarlet, Violet, and Jet Black (produced by TURNER COLOR WORKS LTD.) are preferred.

Moreover, food colored compounds can also be used as the colored material precursor, and examples thereof may include Food Red No. 2 Amaranth, Food Red No. 3 Erythrosine, Food Red No. 102 New Coccine, Food Red No. 104 Phloxine, Food Red No. 105 Rose Bengal, Food Red No. 106 Acid Red, Food Blue No. 1 Brilliant Blue, Food Red No. 40 Allura Red, Food Blue No. 2 Indigo Carmine, Red No. 226 Helindone Pink CN, Red No. 227 Fast Acid Magenta, Red No. 230 Eosine YS, Green No. 204 Pyranine Conc, Orange No. 205 Orange II, Blue No. 205 Alphazurine, Purple No. 401 Alizurol Purple, and Black No. 401 Naphthol Blue Black, which are produced by Daiwa Dyestuff Mfg. Co., Ltd. In addition, naturally-occurring colored compounds can also be used, and examples thereof may include Hi Red G-150 (water soluble, grape skin color), Cochineal Red AL (water soluble, cochineal color), Hi Red MC (water soluble, cochineal dye), Hi Red BL (water soluble, beet red), Daiwamonas LA-R (water soluble, monascus color), Hi Red V80 (water soluble, purple sweet potato color), Annatto N2R-25 (water dispersible, annatto color), Annatto WA-20 (water soluble annatto, annatto color), Hi Orange SS-44R (water dispersible, low viscosity, paprika color), Hi Orange LH (oil soluble, paprika color), Hi Green B (water soluble, green coloring agent), Hi Green F (water soluble, green coloring agent), Hi Blue AT (water soluble, gardenia blue color), Hi Melon P-2 (water soluble, green coloring agent), Hi Orange WA-30 (water dispersible, paprika color), Hi Red RA-200 (water soluble, red radish color), Hi Red CR-N (water soluble, red cabbage color), Hi Red EL (water soluble, elderberry color), and Hi Orange SPN (water dispersible, paprika color), which are produced by Daiwa Dyestuff Mfg. Co., Ltd.

The colored material precursor to be used is preferably selected from compounds which are represented by the general formula [R2-X2] above and are soluble or dispersible at a predetermined concentration in a solvent used in the process for producing the transparent conductive film 12.

### (Dispersant)

In the transparent conductive film 12 illustrated in FIG. 1, the dispersant 25 is adsorbed to the surface of the metal filler 21. The adsorption here has the same meaning as the adsorption of the colored self-assembled material described above.

As the dispersant 25, those allowing easy dispersion of the metal filler 21 in a solvent are preferred. As the dispersant 25, for example, polyvinylpyrrolidone (PVP) or amino group-containing compounds such as polyethyleneimine can be used. In addition to these, compounds can also be used which have functional groups such as a sulfo group (including sulfonate), a sulfonyl group, a sulfonamide group, a carboxylic acid group (including carboxylate, an amide group, a phosphate group (including phosphoric acid salts and phosphoric acid esters), a phosphino group, a silanol group, an epoxy group, an isocyanate group, a cyano group, a vinyl group, a thiol group, and a carbinol group and which can improve the dispersibility of the metal filler 21 in a solvent. These dispersants may be used not only singly but also in any combination of two or more thereof. The dispersant 25 is preferably adsorbed to the metal filler 21 in such an amount that the conductivity of the transparent conductive film 12 does not deteriorate.

### [Effect]

As described above, according to the first embodiment, the colored self-assembled material 23 is adsorbed to the surface of the metal filler 21 in the transparent conductive film 12, thereby producing the transparent conductive film 12 which prevents an increase in resistance (for example, sheet resistance) and further has high contrast.

The colored self-assembled material 23 have the function of absorbing light which is scattered on the surface of the metal filler 21 to cause milky appearance (whitish appearance). The light which causes milky appearance (whitish appearance) hardly passes through conventional transparent conductive films. Therefore, the modification of the surface of the metal filler 21 even with the colored self-assembled material 23 suppresses the lowering of the transparency of the transparent conductive film 12.

### <Modifications>

### (Modification 1)

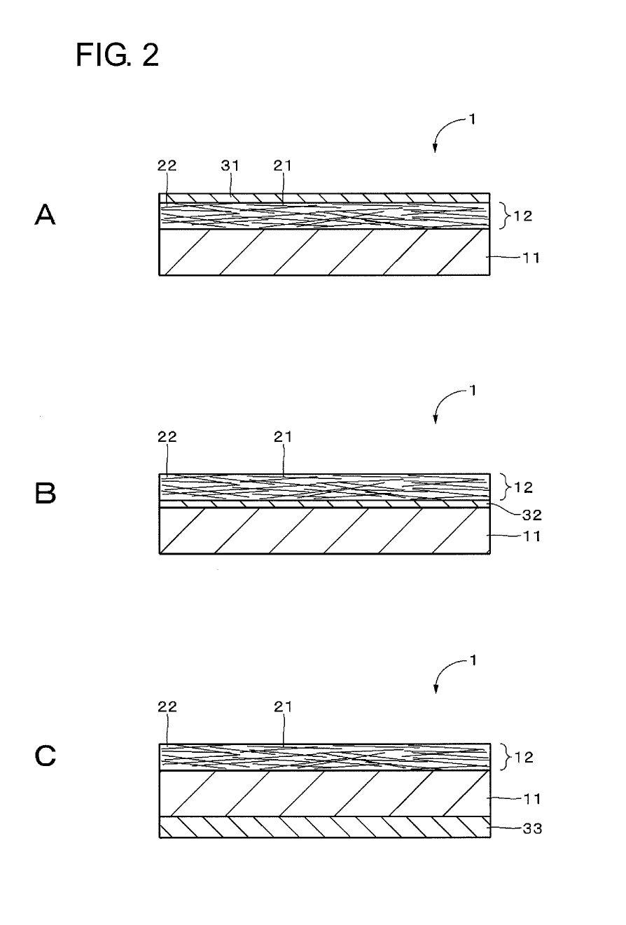

As illustrated in the cross-sectional diagram A of FIG. 2, the transparent conductive element 1 may further include an overcoat layer 31 on the surface of the transparent conductive film 12. The overcoat layer 31 is provided for protecting the transparent conductive film 12 including the metal filler 21. The overcoat layer 31 is preferably transparent to visible light. The overcoat layer 31 includes, for example, a polyacryl-based resin, a polyamide-based resin, a polyester-based resin, or a cellulose-based resin, or includes a hydrolysis product or a dehydration condensation product of a metal alkoxide, or the like. The overcoat layer 31 preferably has such a thickness as to keep the transparency to visible light. The overcoat layer 31 may have at least one function selected from the group consisting of a hard coat function, an anti-glare function, an anti-reflection function, an anti-Newton ring function, an anti-blocking function, and the like.

### (Modification 2)

As illustrated in the cross-sectional diagram B of FIG. 2, the transparent conductive element 1 may further include an anchor layer 32 between the substrate 11 and the transparent conductive film 12. The anchor layer 32 is provided for improving the adhesion between the substrate 11 and the transparent conductive film 12.

The anchor layer 32 is preferably transparent to visible light. The anchor layer 32 includes a polyacryl-based resin, a polyamide-based resin, a polyester-based resin, or a cellulose-based resin, or includes a hydrolysis product or a dehydration condensation product of a metal alkoxide, or the like.

### (Modification 3)

As illustrated in the cross-sectional diagram C of FIG. 2, the transparent conductive element 1 may further include a hard coat layer 33 on the surface of the substrate 11. The hard coat layer 33 is provided on one main surface of the substrate 11 which is opposite to the other main surface to be provided with the transparent conductive film 12. The hard coat layer 33 is provided for protecting the substrate 11.

The hard coat layer 33 is preferably transparent to visible light, and includes an organic hard coat agent, an inorganic hard coat agent, an organic-inorganic hard coat agent, and the like. The hard coat layer 33 preferably has such a thickness as to keep the transparency to visible light.

### (Modification 4)

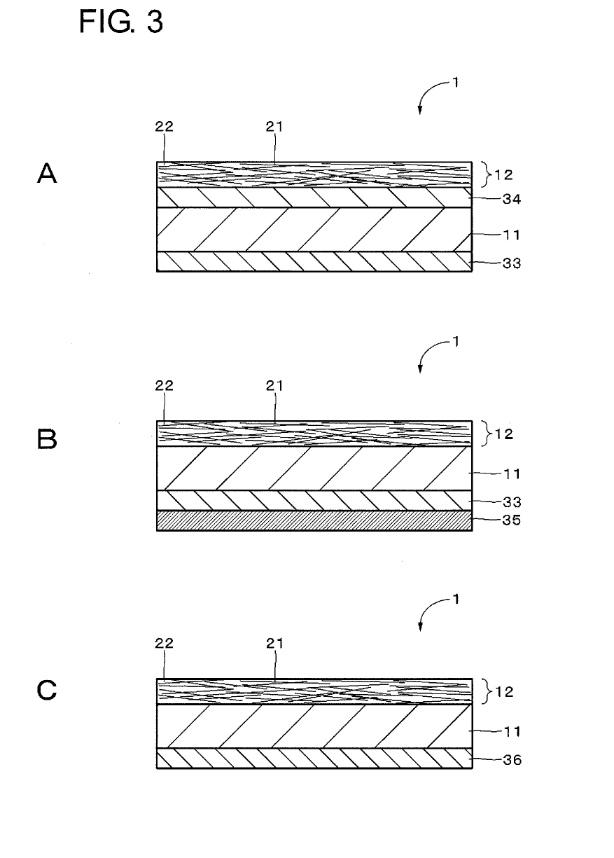

As illustrated in the cross-sectional diagram A FIG. 3, the transparent conductive element 1 may further include hard coat layers 33 and 34 on respective sides of the substrate 11. The hard coat layer 34 is provided on one main surface of the substrate 11 to be provided with the transparent conductive film 12. Whereas, the hard coat layer 33 is provided on one main surface of the substrate 11 which is opposite to the other main surface to be provided with the transparent conductive film 12. The hard coat layers 33 and 34 are provided for protecting the substrate 11.

The hard coat layers 33 and 34 are preferably transparent to visible light, and include an organic hard coat agent, an inorganic hard coat agent, an organic-inorganic hard coat agent, and the like. The hard coat layers 33 and 34 preferably have such a thickness as to keep the transparency to visible light.

### (Modification 5)

As illustrated in the cross-sectional diagram B of FIG. 3, the transparent conductive element 1 may further include a hard coat layer 33 on the surface of the substrate 11 and an anti-reflection layer 35 on the surface of the hard coat layers 33. The hard coat layer 33 and the anti-reflection layer 35 are provided on one main surface of the substrate 11 which is opposite to the other main surface to be provided with the transparent conductive film 12. As the anti-reflection layer 35, for example, a low refractive index layer can be used, but the anti-reflection layer 35 is not limited to this.

### (Modification 6)

As illustrated in the cross-sectional diagram C of FIG. 3, the transparent conductive element 1 may further include an anti-reflection layer 36 on the surface of the substrate 11. The anti-reflection layer 36 is provided on one main surface of the substrate 11 which is opposite to the other main surface to be provided with the transparent conductive film 12. As the anti-reflection layer 36, for example, a moth-eye structure layer or a shape-transferred, anti-reflection layer (shape-transferred AR (Anti-reflection) layer) can be used.

### (Modification 7)

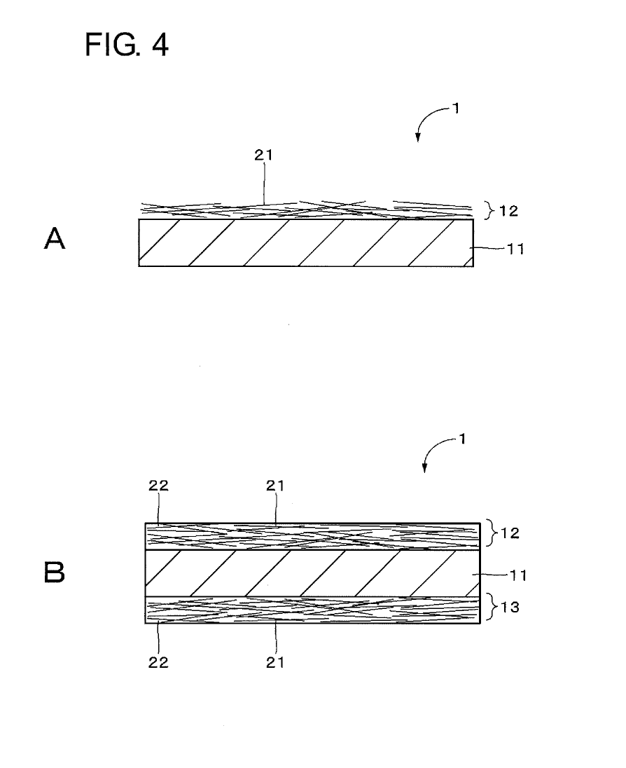

As illustrated in the cross-sectional diagram A of FIG. 4, the transparent conductive film 12 may have no resin material 22. On the surface of the substrate 11, the metal filler 21 modified with the colored self-assembled material 23 accumulates without being dispersed in the resin material 22. The transparent conductive film 12 including the accumulation of the metal filler 21 is provided on the surface of the substrate 11 while keeping the adhesion with the surface of the substrate 11. This configuration can be preferably applied when the adhesion between the metal fillers 21 and the adhesion between the metal filler 21 and the substrate 11 are satisfactory. Even the transparent conductive element 1 having such a configuration has the same effect as the transparent conductive element 1 having the configuration described in the first embodiment because of the modification of the surface of the metal filler 21 with the colored self-assembled material 23.

### (Modification 8)

As illustrated in the cross-sectional diagram B of FIG. 4, the transparent conductive element 1 may further include a transparent conductive film 13 on the surface of the substrate 11. The transparent conductive film 13 is provided on one main surface of the substrate 11 which is opposite to the other main surface to be provided with the transparent conductive film 12. As the configuration of the transparent conductive film 13, the same configuration as of the transparent conductive film 12 in the first embodiment above can be employed.

### 2. Second Embodiment

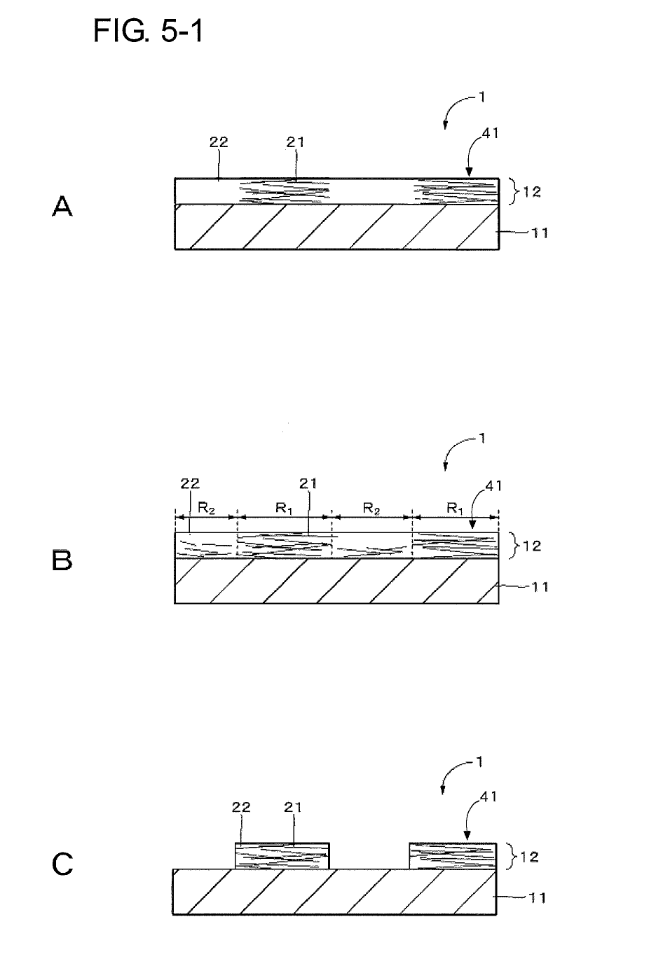

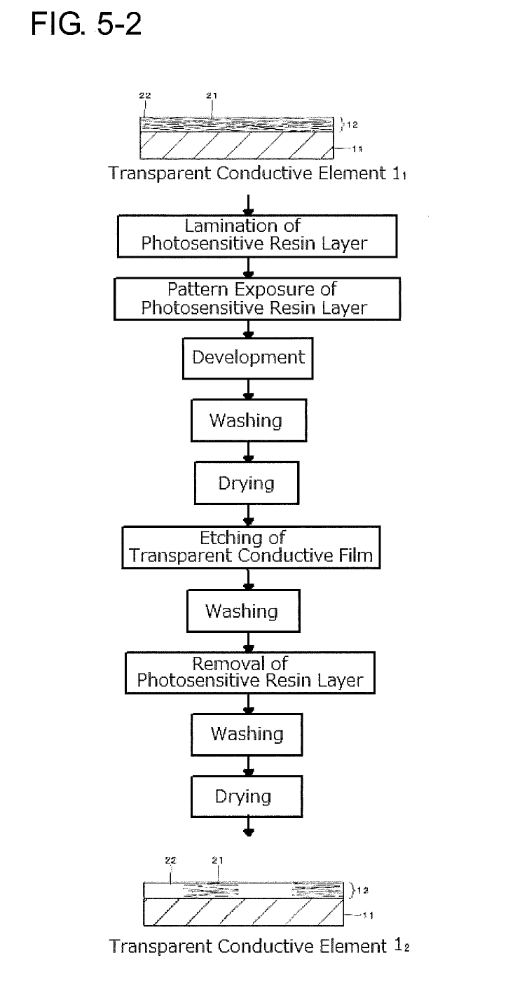

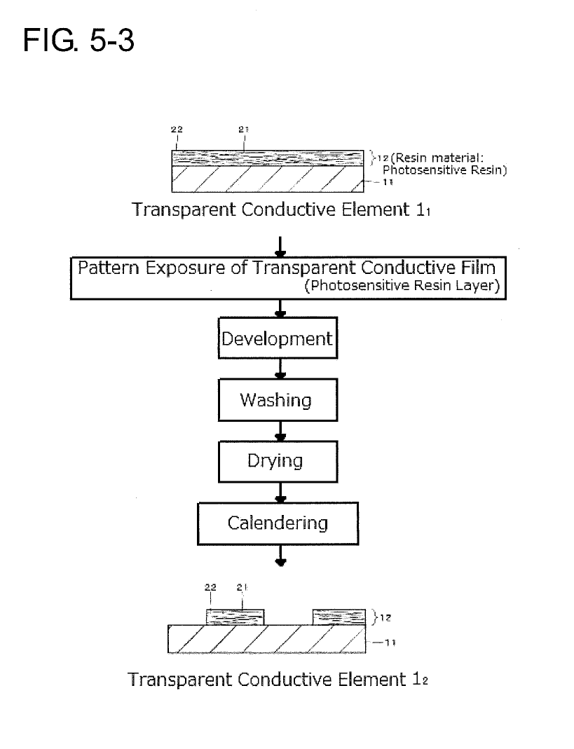

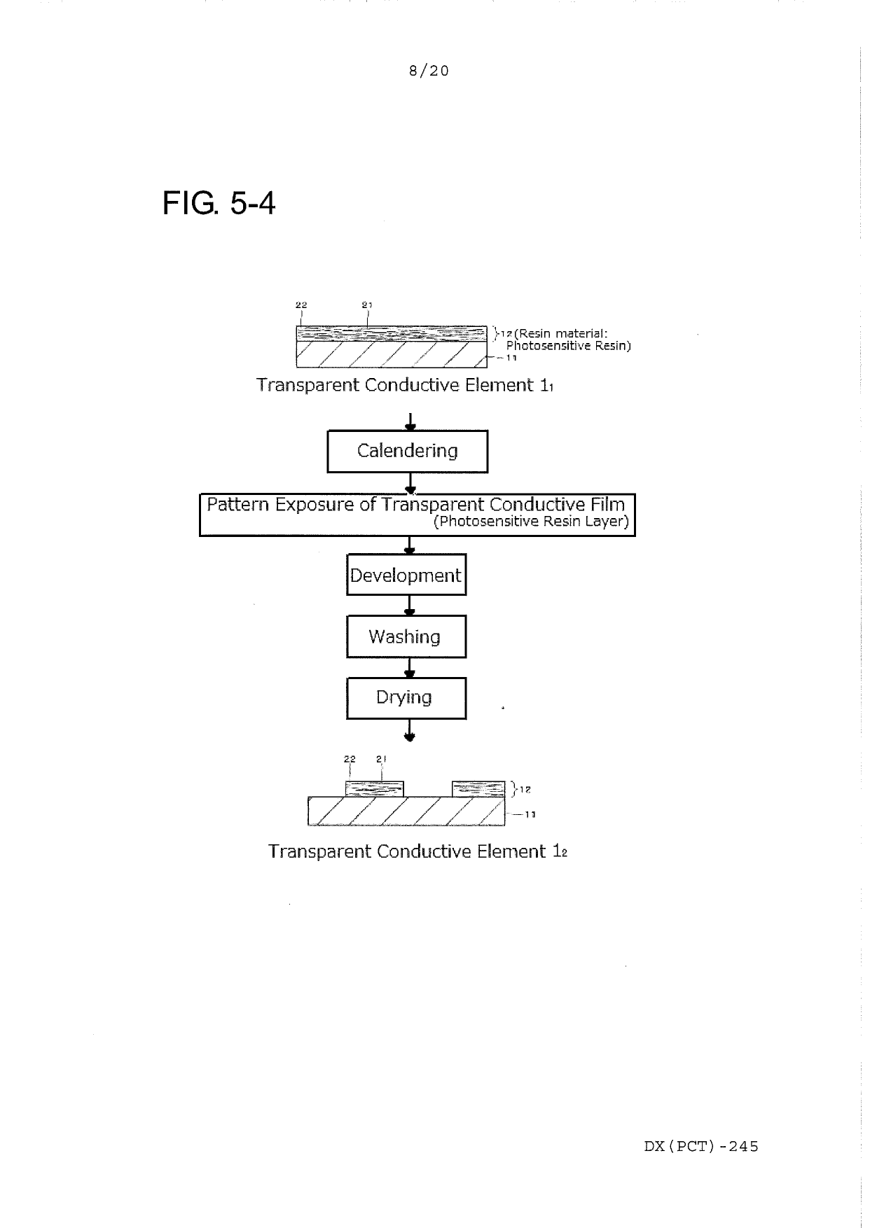

The cross-sectional diagram A of FIG. 5-1 illustrates an example of a configuration of a transparent conductive element according to a second embodiment of the present technique. As illustrated in the cross-sectional diagram A of FIG. 5-1, the transparent conductive element 1 according to the second embodiment is different from the transparent conductive element 1 according to the first embodiment in that the metal filler 21 of the transparent conductive film 12 is patterned. The patterned transparent conductive film 12 includes, for example, an electrode 41 such as an X electrode or a Y electrode. Examples of the shape of the electrode 41 may include a stripe shape (linear shape) and a shape where a plurality of pads (unit electrodes) having a predetermined shape are linearly connected, but the shape is not particularly limited thereto.

As the patterning method, for example, as illustrated in FIG. 5-2, a photosensitive resin layer is laminated on the surface of the transparent conductive film 12 of a transparent conductive element 1₁ obtained in the first embodiment, followed by pattern exposure, development, washing, and drying in sequence to pattern a photosensitive resin film on the surface of the transparent conductive film 12.

The pattern exposure here can be either mask exposure or laser exposure.

For the development, alkaline aqueous solutions (for example, a sodium carbonate aqueous solution, a sodium hydrogen carbonate aqueous solution, a tetramethylammonium hydroxide aqueous solution) or acid aqueous solutions (for example, an acetic acid solution) are used depending on the type of the photosensitive resin film.

Next, the patterned photosensitive resin layer is used as a mask for etching the transparent conductive film 12. An etching solution is appropriately selected according to the types of the metal filler 21 and the resin material 22 which constitute the transparent conductive film 12. For example, a hydrochloric acid aqueous solution of copper chloride is used for etching the metal filler 21. The etched metal filler 21 is washed with water or the like, and the photosensitive resin layer on the surface is removed by an alkaline aqueous solution or the like. The metal filler 21 was washed with water again and dried. In this manner, a transparent conductive element 1₂ according to the second embodiment having the patterned transparent conductive film 12 can be obtained.

When the resin material constituting the transparent conductive element obtained in the first embodiment is a photosensitive resin, the laminating and the patterning of the photosensitive resin layer in the process illustrated above in FIG. 5-2 can be eliminated, so that the resin material 22 as well as the metal filler 21 can be patterned as illustrated in the cross-sectional diagram C of FIG. 5-1. Specifically, as illustrated in FIG. 5-3, a transparent conductive element 1₁ is subjected to the steps of direct pattern exposure, development, washing, and drying in sequence to obtain a transparent conductive element 1₂ according to the second embodiment.

The pattern exposure here can also be either mask exposure or laser exposure.

In the development, for example, alkaline aqueous solutions (for example, a sodium carbonate aqueous solution, a sodium hydrogen carbonate aqueous solution, a tetramethylammonium hydroxide aqueous solution) or acid aqueous solutions (for example, an acetic acid solution) are appropriately used depending on the types of the metal filler 21 and the resin material 22 which constitute the transparent conductive film 12.

For the washing, water or alcohols (for example, methanol, ethanol, n-propanol, i-propanol, n-butanol, i-butanol, sec-butanol, and tert-butanol) are used as a washing liquid. The transparent conductive film 12 is immersed in the washing liquid, or the washing liquid is showered on the transparent conductive film 12.

In the production process in FIG. 5-3, calendering is preferably carried out after the drying step to increase the conductivity of the transparent conductive film 12. Alternatively, as illustrated in FIG. 5-4, calendering may be carried out before the pattern exposure step (i.e., after the application of a dispersion for forming the transparent conductive film to the substrate 11 followed by drying and before the pattern exposure).

### (Modification)

As illustrated in the cross-sectional diagram B of FIG. 5-1, the transparent conductive film 12 may include conductive regions R₁ and insulating regions R₂ in the in-plane direction of the substrate 11. The conductive regions R₁ form an electrode 41 such as an X electrodes or a Y electrode. Meanwhile, the insulating regions R₂ form insulating parts which insulate between the conductive regions R₁. In the insulating region R₂, for example, at least the metal filler 21 is in the insulating state as being separated from the conductive regions R₁. Examples of a method of separating the metal filler 21 may include an etching method. In this case, complete etching can be avoided by controlling the liquid composition, the treatment temperature, and the treatment time which are used for the etching (development when the resin constituting the transparent conductive film 12 is a photosensitive resin) of the transparent conductive film 12 while forming the insulating regions R₂. In this manner, the formation of the insulating regions R₂ without complete etching can increase the invisibility of the electrode pattern.

The configurations of modifications 1 to 8 in the first embodiment above can be applied to the transparent conductive element 1 according to the second embodiment and the modifications thereof.

### 3. Third Embodiment

### Method of Producing Transparent Conductive Element

Next, as an example of a method of producing a transparent conductive element, described will be the method involving first forming a dispersion film of the metal filler 21 and next treating the surface of the metal filler 21 in the dispersion film with the colored self-assembled material 23.

### (1) Preparation of Dispersion of Metal Filler

First, a dispersion of the metal filler 21 dispersed in a solvent is prepared. Here, the metal filler 21 is added together with a resin material (binder) to the solvent. In this embodiment, the above photosensitive resins can also be used as the resin material. If necessary, a dispersant for improving the dispersibility of the metal filler 21 and other additives for improving the adhesion and the durability are mixed.

As dispersion technique, stirring, ultrasonic dispersion, bead dispersion, kneading, homogenizer processing, and the like can be preferably employed.

Given that the mass of the dispersion is 100 parts by mass, the amount of the metal filler 21 in the dispersion is from 0.01 to 10.00 parts by mass. When the amount of the metal filler 21 is less than 0.01 parts by mass, a sufficient basis weight (for example, 0.001 to 1.000 [g/m²]) of the metal filler 21 is not obtained in the transparent conductive film 12 to be finally obtained. In contrast, when the amount of the metal filler 21 is more than 10 parts by mass, the dispersibility of the metal filler 21 tends to deteriorate. When a dispersant is added to the dispersion, the amount of the dispersant added is preferably such that the conductivity of the transparent conductive film 12 to be finally obtained does not deteriorate.

As the solvent for producing the above dispersion, solvents capable of dispersing the metal filler are used. The solvent to be used is at least one selected from, for example, water, alcohols (for example, methanol, ethanol, n-propanol, i-propanol, n-butanol, i-butanol, sec-butanol, tert-butanol), anones (for example, cyclohexanone, cyclopentanone), amides (for example, N,N-dimethylformamide: DMF), sulfides (for example, dimethyl sulfide), and dimethyl sulfoxide (DMSO).

In order to suppress uneven drying and cracks of the dispersion film which is formed using the dispersion, the evaporation rate of the solvent from the dispersion can be controlled by further addition of a high-boiling point solvent to the dispersion. Examples of the high-boiling point solvent may include butyl cellosolve, diacetone alcohol, butyltriglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, and methyl glycol. These high-boiling point solvents may be used singly or in any combination of a plurality of them.

### (2) Formation of Dispersion Film

Next, a dispersion film of the metal filler 21 is formed on the substrate 11 using the dispersion prepared as described above. Although a method of forming the dispersion film is not particularly limited, a wet film formation method is preferred in consideration of physical properties, convenience, production cost, and the like. As the wet film formation method, known methods such as a coating method, a spray method, and a printing method are employed. There is no particular limitation on coating methods and known coating methods can be used. Examples of known coating methods may include a microgravure coating method, a wire bar coating method, a direct gravure coating method, a die coating method, a dipping method, a spray coating method, a reverse roll coating method, a curtain coating method, a comma coating method, a knife coating method, and a spin coating method. Examples of printing methods may include relief printing, offset printing, gravure printing, intaglio printing, rubber printing, screen printing, and ink jet printing.

These conditions form the dispersion film where the metal filler 21 is dispersed in a solvent containing the uncured resin material (binder) 22.

### (3) Drying and Curing of Dispersion Film

Next, the solvent in the dispersion film formed on the substrate 11 is removed by drying. The removal of the solvent by drying can be either by natural drying or by heat drying. Subsequently, the uncured resin material 22 is cured so that the metal filler 21 is dispersed in the cured resin material 22. Next, pressure treatment may be optionally carried out by calendering in order to decrease the sheet resistance value of the transparent conductive film 12 to be obtained.

### (4) Modification of Surface of Metal Filler

Next, the process of treating the surface of the metal filler in the dispersion film with the colored self-assembled material 23 will be described in detail. This process of treating the surface includes a method (4-1) where the colored self-assembled material 23 is adsorbed directly to the surface of the metal filler 21 in the dispersion film “hereinafter, referred to as a “direct formation method”), and a method (4-2) where the self-assembled material 23a is first adsorbed to the surface of the metal filler 21 in the dispersion film and the colored material 23b is next bound to the self-assembled material 23a so that the colored self-assembled material 23 is adsorbed to the metal filler 21, so-called “indirect formation method.” In the following description, the process of treating the surface will be described in detail for the direct formation method (4-1) and the indirect formation method (4-2).

### (4-1) Direct Formation Method

In the direct formation method, the colored self-assembled material 23 is first dissolved in a solvent unreactive to this material to prepare a treatment solution. Next, the dispersion film where the resin material 22 is uncured or cured is treated with this treatment solution to form a colored self-assembled film on the metal filler 21 at least on the surface of the dispersion film, preferably on the metal filler 21 on the surface of and in the dispersion film.

A method of forming the colored self-assembled film by the direct formation method after the curing of the resin material 22 in the dispersion film will be described below in detail.

### (4-1-1) Preparation of Treatment Solution

The colored self-assembled material 23 is first mixed with a solvent unreactive to this material under stirring to prepare a treatment solution. The solvent is not particularly limited as long as being capable of dissolving the colored self-assembled material 23. Specific examples of the solvent may include dimethyl sulfoxide, N,N-dimethylformamide, ethanol, and water.

The concentration of the colored self-assembled material 23 is preferably 0.01% by mass or more to improve the adsorption rate of the colored self-assembled material 23 to the surface of the metal filler.

### (4-1-2) Adsorption Treatment of Colored Self-Assembled Material

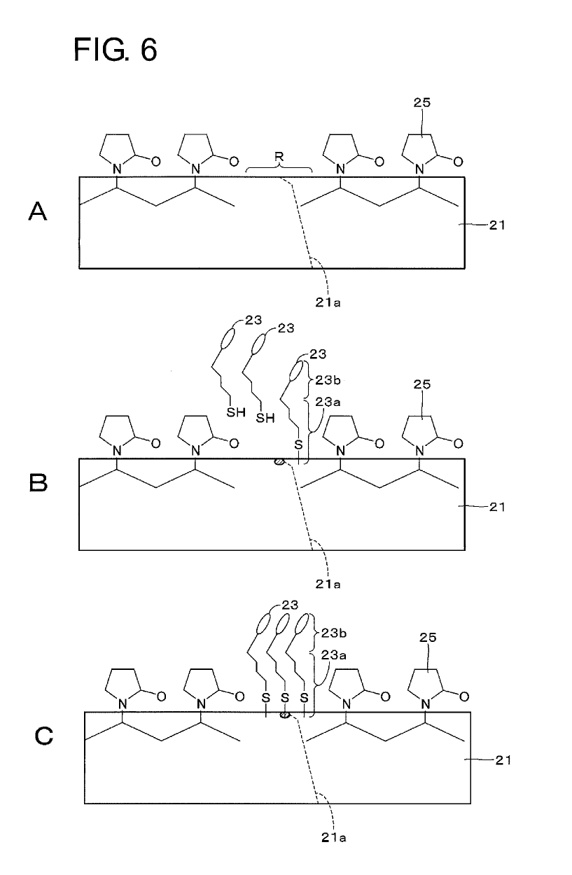

Next, the dispersion film where the metal filler 21 is dispersed in the cured resin material 22 is brought into contact with the treatment solution. As illustrated in the schematic diagrams B and C of FIG. 6, this contact allows the colored self-assembled material 23 in the treatment solution to be adsorbed to the surface of the metal filler 21 exposed on the surface of the dispersion film via thiol groups, sulfide groups, and the like. Alternatively, the dispersion film is swelled with the treatment solution to allow permeation of the colored self-assembled material 23 so that the colored self-assembled material 23 is also adsorbed to the surface of the metal filler 21 in the dispersion film. The colored self-assembled material 23 is preferentially adsorbed to a crystal grain boundary 21a and part R which is not protected by the dispersant 25 in the surface of the metal filler 21. At the same time, in the parts protected by the dispersant 25, the colored self-assembled material 23 replaces the dispersant 25 and is adsorbed to the surface of the metal filler 21. The treatment even with the colored self-assembled material 23 causes no or little change in the sheet resistance. As illustrated in the schematic diagram C of FIG. 6, this treatment allows a colored self-assembled monolayer containing the colored self-assembled material 23 to be formed on the surface of the metal filler 21.

Specific examples of such adsorption treatment may include an immersion process in which the dispersion film of the metal filler 21 is immersed in the treatment solution, and a coating process or a printing process in which a liquid film of the treatment solution is formed on the dispersion film.

When the immersion process is employed, the treatment solution is prepared in an amount sufficient to immerse the dispersion film, and the dispersion film is immersed in the treatment solution for 0.1 seconds to 48 hours. Meanwhile, at least one of heating and ultrasonication is performed to increase the adsorption rate of the colored self-assembled material 23 to the metal filler 21. After the immersion, the dispersion film is optionally washed with a good solvent for the colored self-assembled material 23 to remove the unabsorbed colored self-assembled material 23 which remains in the dispersion film.

When the coating process is employed, an appropriate method is selected from, for example, a microgravure coating method, a wire bar coating method, a direct gravure coating method, a die coating method, a dipping method, a spray coating method, a reverse roll coating method, a curtain coating method, a comma coating method, a knife coating method, and a spin coating method to form a liquid film of the treatment solution on the dispersion film.

When the printing process is employed, an appropriate method is selected from, for example, a relief printing method, an offset printing method, a gravure printing method, an intaglio printing method, a rubber printing method, an ink jet printing method, and a screen printing method to form a liquid film of the treatment solution on the dispersion film.

When the coating process or the printing process is employed, at least one of heating and ultrasonication is performed while a liquid film containing a given amount of the treatment solution is formed on the dispersion film, thereby increasing the adsorption rate of the colored self-assembled material 23 to the metal filler 21. At a certain period of time after the formation of the liquid film of the treatment solution, the dispersion film is optionally washed with a good solvent for the colored self-assembled material 23 to remove the unabsorbed colored self-assembled material 23 which remains in the dispersion film.

The formation of the colored self-assembled film with a given amount of the treatment solution may not be necessarily achieved by forming the colored self-assembled film one time, or may be achieved by repeating the steps of forming and washing the colored self-assembled film several times.

### (4-1-3) Drying Process

After the above adsorption treatment, the transparent conductive film 12 is subjected to a drying process. The drying process here may be natural drying, or may be heat drying in a heating apparatus.

### (4-1) Indirect Formation Method

In the indirect formation method, the dispersion film is first treated with a first treatment solution containing the self-assembled material 23a. This treatment causes adsorption of the self-assembled material 23a to the surface of the metal filler 21 so that the self-assembled film having an array of the self-assembled materials 23a is formed on the surface of the metal filler 21, in the same manner as in the above direct formation method where the colored self-assembled material 23 is adsorbed to the surface of the metal filler 21. The terminal functional group of the self-assembled material 23a forming the self-assembled film (functional group at the side opposite to the end adsorbed to the metal filler) is, for example, amine. It is noted that the terminal functional group is not limited to this as long as being a functional group that reacts with and binds to the functional group of the colored material 23b such as acid chloride. Next, the dispersion film is treated with a second treatment solution containing the colored material 23b to color the self-assembled film formed on the surface of the metal filler.

The indirect formation method will be described below in detail.

### (4-2-1) Preparation of First Treatment Solution

First, the self-assembled material 23a is mixed with a solvent unreactive to this material under stirring to prepare the first treatment solution. The solvent is not particularly limited as long as being capable of dissolving the self-assembled material 23a. Specific examples of the solvent may include dimethyl sulfoxide, N,N-dimethylformamide, ethanol, and water.

The concentration of the self-assembled material 23a in the first treatment solution is preferably 0.01% by mass or more to improve the adsorption rate of the self-assembled material 23a to the surface of the metal filler 21.

(4-2-2) Adsorption Treatment of Self-Assembled Material with First Treatment Solution

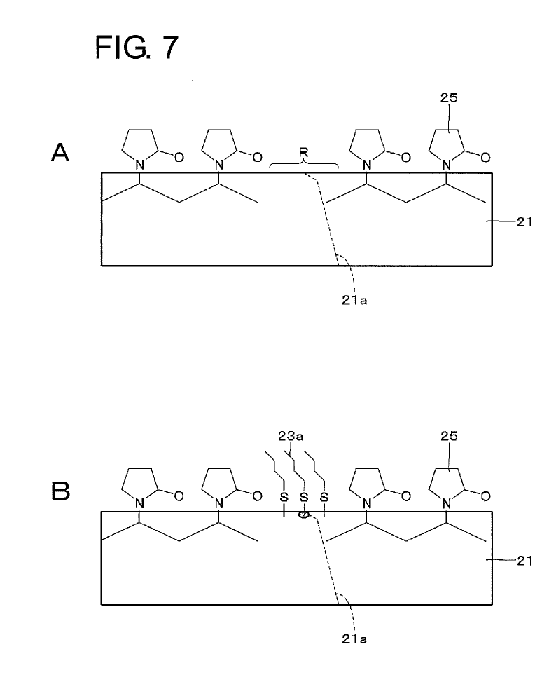

Next, the dispersion film where the metal filler 21 is dispersed in the dried or cured resin material 22 is brought into contact with the first treatment solution. Accordingly, the contact of the above first treatment solution with the metal filler 21 causes adsorption of the self-assembled material 23a to the surface of the metal filler via thiol groups, sulfide groups, and the like, as illustrated in the schematic diagram B of FIG. 7. The self-assembled material 23a is preferentially adsorbed to a crystal grain boundary 21a and part R which is not protected by the dispersant 25 in the surface of the metal filler. Meanwhile, as illustrated in the schematic diagram A of FIG. 7, the self-assembled material 23a replaces the dispersant 25 and is adsorbed to the surface of the metal filler 21, even in the parts protected by the dispersant 25. The treatment even with the self-assembled material 23a causes no or little change in the sheet resistance. As illustrated in the schematic diagram B of FIG. 7, this treatment allows a self-assembled monolayer containing the self-assembled material 23a to be formed on the surface of the metal filler 21.

Specific examples of such adsorption treatment may include immersion process in which the dispersion film of the metal filler 21 is immersed in the first treatment solution, and coating process or printing process in which a liquid film of the first treatment solution is formed on the dispersion film.

When the immersion process is employed, the first treatment solution is prepared in an amount sufficient to immerse the dispersion film, and the dispersion film is immersed in the first treatment solution for 0.1 seconds to 48 hours. Meanwhile, at least one of heating and ultrasonication is performed to increase the adsorption rate of the self-assembled material 23a to the metal filler 21. After the immersion, the dispersion film is optionally washed with a good solvent for the self-assembled material 23a to remove the unabsorbed self-assembled material 23a which remains in the dispersion film.

When the coating process is employed, an appropriate method is selected from, for example, a microgravure coating method, a wire bar coating method, a direct gravure coating method, a die coating method, a dipping method, a spray coating method, a reverse roll coating method, a curtain coating method, a comma coating method, a knife coating method, and a spin coating method to form a liquid film of the first treatment solution on the dispersion film.

When the printing process is employed, an appropriate method is selected from, for example, a relief printing method, an offset printing method, a gravure printing method, an intaglio printing method, a rubber printing method, an ink jet printing method, and a screen printing method to form a liquid film of the first treatment solution on the dispersion film.

When the coating process or the printing process is employed, at least one of heating and ultrasonication is performed while a liquid film containing a given amount of the first treatment solution is formed on the dispersion film, thereby increasing the adsorption rate of the self-assembled material 23a to the metal filler 21. At a certain period of time after the formation of the liquid film of the first treatment solution, the dispersion film is optionally washed with a good solvent for the colored self-assembled material 23 to remove the unabsorbed self-assembled material 23a which remains in the dispersion film.

The formation of the liquid film containing a given amount of the first treatment solution may not be necessarily achieved by forming the liquid film one time, or may be achieved by repeating the above steps of forming and washing the liquid film several times.

### (4-2-3) Drying Process

After the above adsorption treatment, the dispersion film is subjected to a drying process. The drying process here may be natural drying, or may be heat drying in a heating apparatus.

### (4-2-4) Preparation of Second Treatment Solution

First, the colored material 23b is dissolved in a solvent unreactive to this material under stirring to prepare the second treatment solution. The solvent is not particularly limited as long as being capable of dissolving the colored material 23b. Specific examples of the solvent may include dimethyl sulfoxide, N, N-dimethylformamide, ethanol, and water.

The concentration of the colored material 23b is preferably 0.01% by mass or more to improve the reaction rate between the colored material 23b and the self-assembled material 23a adsorbed to the surface of the metal filler 21.

(4-2-5) Binding Process of Colored Material with Second Treatment Solution

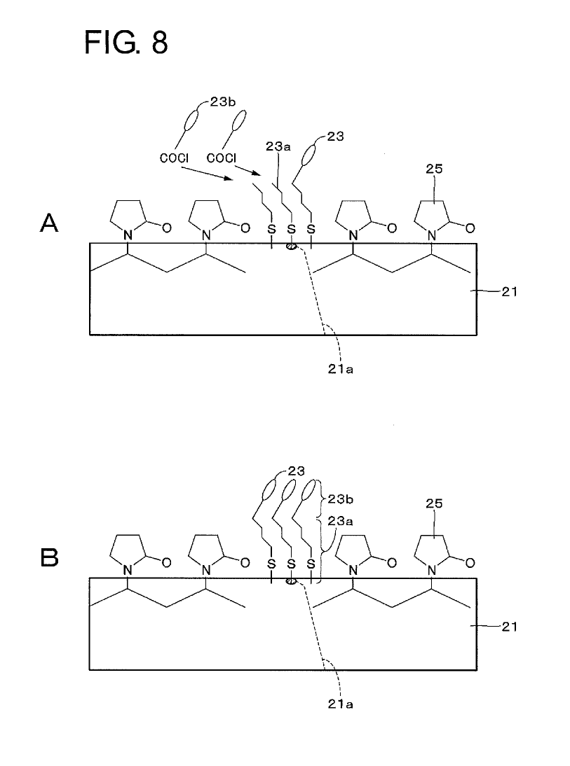

Next, the dispersion film treated with the first treatment solution is brought into contact with the second treatment solution. As illustrated in the schematic diagram A of FIG. 8, an acid chloride (for example, “R—COCl”) of the colored material 23b contained in the second treatment solution is reacted with and bound to the terminal functional group (for example, “—NH₂”) of the self-assembled material 23a adsorbed to the surface of the metal filler 21 to form the colored self-assembled material 23 on the surface of the metal filler. As illustrated in the schematic diagram B of FIG. 8, this allows a self-assembled monolayer containing the colored self-assembled material 23 to be formed on the surface of the metal filler.

Specific examples of such a binding process may include an immersion process in which the dispersion film of the metal filler 21 is immersed in the second treatment solution, and a coating process or a printing process in which a liquid film of the second treatment solution is formed on the dispersion film.

When the immersion process is employed, the second treatment solution is prepared in an amount sufficient to immerse the dispersion film, and the dispersion film is immersed in the second treatment solution for 0.1 seconds to 48 hours. Meanwhile, at least one of heating and ultrasonication is performed to increase the adsorption rate of the colored material 23b to the metal filler 21. After the immersion, the dispersion film is optionally washed with a good solvent for the colored material 23b to remove the unabsorbed colored material 23b which remains in the dispersion film.

When the coating process is employed, an appropriate method is selected from, for example, a microgravure coating method, a wire bar coating method, a direct gravure coating method, a die coating method, a dipping method, a spray coating method, a reverse roll coating method, a curtain coating method, a comma coating method, a knife coating method, and a spin coating method to form a liquid film of the second treatment solution on the dispersion film.

When the printing process is employed, an appropriate method is selected from, for example, a relief printing method, an offset printing method, a gravure printing method, an intaglio printing method, a rubber printing method, an ink jet printing method, and a screen printing method to form a liquid film of the second treatment solution on the dispersion film.

When the coating process or the printing process is employed, at least one of heating and ultrasonication is performed while a liquid film containing a given amount of the second treatment solution is formed on the dispersion film, thereby increasing the reaction rate between the colored material 23b and the self-assembled material 23a adsorbed to the metal filler 21. At a certain period of time after the formation of the liquid film of the second treatment solution, the dispersion film is optionally washed with a good solvent for the colored self-assembled material 23 to remove the unreacted colored material 23b which remains in the dispersion film.

The formation of the liquid film containing a given amount of the second treatment solution may not be necessarily achieved by forming the liquid film one time, or may be achieved by repeating the above steps of forming and washing the liquid film several times.

### (4-2-6) Drying Process

After the above adsorption treatment, the transparent conductive film 12 is subjected to a drying process. The drying process here may be natural drying, or may be heat drying in a heating apparatus.

### (5) Others

As described in the modifications of the first embodiment above, in the case of the production of the transparent conductive element 1 including the overcoat layer 31 on the transparent conductive film 12 (see FIG. 2), the step of forming the overcoat layer 31 on the transparent conductive film 12 may be carried out. In the case of the production of the transparent conductive element 1 including the anchor layer 32 between the substrate 11 and the transparent conductive film 12 (see FIG. 2), the anchor layer 32 is formed on the substrate 11 before the formation of the dispersion film. After that, the step of forming the dispersion film on the anchor layer 32 and subsequent steps may be carried out.

In the case of the production of the transparent conductive film 12 having no resin material 22 (see the cross-sectional diagram A of FIG. 4), the dispersion is prepared using the metal filler and the solvent without using the resin material 22, and the liquid film of the dispersion is formed on the substrate 11. Next, the solvent is removed from the liquid film of the dispersion formed on the substrate 11, so that the metal filler 21 is accumulated while being substantially uniformly dispersed, in the part where the liquid film of the dispersion is formed on the substrate 11. This forms the dispersion film containing the metal filler 21. After that, the first treatment solution and the second treatment solution are sequentially brought into contact with this dispersion film in the same procedure as described above.

### [Effect]

According to the production method of the third embodiment as described above, the transparent conductive film 12 where the surface of the metal filler 21 is modified with the colored self-assembled material 23 can be inexpensively produced by a simple method without using a vacuum process.

### [Modification]

The method of producing the transparent conductive element according to the third embodiment as described above may further include the step of patterning the transparent conductive film 12 to form an electrode pattern. Examples of the patterning method may include the same pattern etching of the dispersion film or the transparent conductive film 12 as the patterning in the method of producing the transparent conductive element according to the second embodiment, after the step of drying or curing the dispersion. In this case, in regions outside the electrode pattern in the dispersion film or the transparent conductive film 12, instead of the removal of the transparent conductive film 12, the pattern may be etched to divide at least the metal filler 21 so that the conductive regions R₁ are insulated from the insulating regions R₂, respectively, as illustrated in the schematic diagram B of FIG. 5-1.

Instead of the above patterning method, the dispersion film which is patterned in advance, for example, by a printing method may be formed in the step of forming the dispersion film. Examples of the printing method to be used may include a relief printing method, an offset printing method, a gravure printing method, an intaglio printing method, a rubber printing method, an ink jet printing method, and a screen printing method.

### 4. Fourth Embodiment

Next, as an example of a method of producing of the transparent conductive element, the method involving forming the dispersion film of the metal filler after the modification of the surface of the metal filler 21 with the colored self-assembled material 23 will be described.

### (Preparation of Dispersion)

First, the colored self-assembled material 23 is added to a dispersion of the metal filler 21 in a solvent to modify the surface of the metal filler 21 in the dispersion with the colored self-assembled material 23 in advance. This modification can produce a dispersion of the metal filler 21 with the colored self-assembled material 23 being adsorbed thereto.

Alternatively, the dispersion may be prepared in the following manner. First, the self-assembled material 23a is added to a dispersion of the metal filler 21 in a solvent to modify the surface of the metal filler 21 in the dispersion with the self-assembled material 23a in advance. The terminal functional group of the self-assembled material 23a is, for example, amine. It is noted that the terminal functional group is not limited to this as long as being a functional group that reacts with and binds to the functional group of the colored material 23b such as acid chloride. Next, the colored material 23b is added to the dispersion of the metal filler 21 with the self-assembled material 23a being adsorbed thereto to bind the colored material 23b to the self-assembled material 23a. This can produce a dispersion of the metal filler having the surface modified with the colored self-assembled material 23.

The concentration of the colored self-assembled material 23 with respect to the dispersion is preferably 0.0001% by mass or more and 0.1% by mass or less. When the concentration is less than 0.0001% by mass, the effect of reducing reflection L is insufficient. In contrast, when the concentration is more than 0.1% by mass, the metal filler 21 tends to aggregate in the dispersion to deteriorate the sheet resistance value and the total light transmittance of the transparent conductive film 12 to be produced.

### (Formation of Dispersion Film)

Next, the uncured resin material 22 is optionally contained in the dispersion prepared as described above to form a dispersion film on the substrate 11. In this dispersion film, the metal filler 21 having the surface modified with the colored self-assembled material 23 is dispersed. Although the method of forming the dispersion film is not particularly limited, examples of the method may include an immersion method and a coating method.

### (Drying and Curing of Dispersion Film)

Next, the solvent in the dispersion film formed on the substrate 11 is removed by drying. Subsequently, the uncured resin material 22 is cured. This provides the transparent conductive film 12 where the metal filler 21 having the modified surface is dispersed. The removal of the solvent by drying and the curing of the uncured resin material 22 are the same as those in the third embodiment above. Subsequently, pressure treatment may be optionally carried out by calendering in order to decrease the sheet resistance value of the transparent conductive film 12 to be obtained. The transparent conductive element 1 of interest is accordingly obtained as described above.

### (Others)

In the above method, the dispersion of the metal filler 21 with the colored self-assembled material 23 being adsorbed thereto is obtained by adding the colored self-assembled material 23 to the dispersion of the metal filler 21 in a solvent, or alternatively by sequentially reacting the self-assembled material 23a and the colored material 23b with the dispersion of the metal filler 21 in a solvent. The uncured resin material 22 is optionally contained in this dispersion, and film formation of the dispersion is conducted on the substrate 11 to form the transparent conductive film 12. In addition to this method, the following method may be employed. A dispersion simultaneously containing the metal filler 21, the colored self-assembled material 23, and the uncured resin material 22 is prepared, or alternatively a dispersion simultaneously containing the metal filler, the self-assembled material 23a, the colored material 23b, and the uncured resin material 22 is prepared. Film formation of this dispersion is then conducted on the substrate 11 to form the transparent conductive film 12. The transparent conductive film 12 is patterned to produce the transparent conductive element 1 of the present invention.

### [Effect]

The production method according to the fourth embodiment can reduce the production process as compared with the production method according to the third embodiment. In this case, the use of a photosensitive resin as a resin material can further simplify the production process of the transparent conductive element having the patterned transparent conductive film.

### 5. Fifth Embodiment

### Configuration of Information Input Device

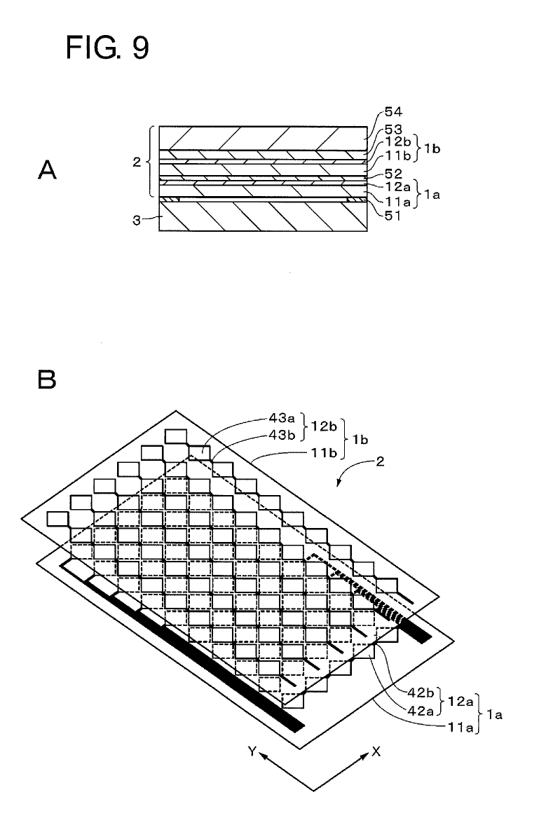

The cross-sectional diagram A of FIG. 9 illustrates an example of a configuration of an information input device according to a fifth embodiment of the present technique. As illustrated in the cross-sectional diagram A of FIG. 9, an information input device 2 is provided on the display screen of a display device 3. The information input device 2 is, for example, attached to the display screen of the display device 3 through a bonding layer 51. The bonding layer 51 may be provided only on the margin between the display screen of the display device 3 and the back side of the information input device 2. As the bonding layer 51, for example, an adhesive paste, an adhesive tape, and the like are used. In this specification, the touch screen (information input screen) side on which information is input by a finger, a pen, or the like is referred to as a “surface”, and the opposite side of the surface is referred to as a “back side.”

### (Display Device)

The display device 3 to which the information input device 2 is applied is not particularly limited, but examples thereof may include various display devices such as liquid crystal displays, cathode ray tube (CRT) displays, plasma display panels (PDP), electroluminescence (EL) displays, and surface-conduction electron-emitter displays (SEDs).

### (Information Input Device)

The information input device 2, a so-called projected-capacitive touch panel, includes a first transparent conductive element 1a and a second transparent conductive element 1b provided on the surface of the first transparent conductive element 1a wherein the first transparent conductive element 1a and the second transparent conductive element 1b are attached to each other through the bonding layer 52.

If necessary, a protective layer (optical layer) 54 may be further provided over the surface of the second transparent conductive element 1b. The protective layer 54 is, for example, a top plate made of glass or plastic. The protective layer 54 and the second transparent conductive element 1b are, for example, attached to each other through the bonding layer 53. The protective layer 54 is not limited to this example, and can be a ceramic coat (overcoat) such as SiO₂.

The perspective view B of FIG. 9 is an exploded perspective view of an example of a configuration of the information input device according to the fifth embodiment of the present technique. In this perspective view, two in-plane orthogonal directions of the first transparent conductive element 1a and the second transparent conductive element 1b are defined as an X-axis direction and a Y-axis direction, respectively.

The first transparent conductive 1a includes a substrate 11a and a transparent conductive film 12a provided on the surface of the substrate 11a. The transparent conductive film 12a is patterned to form an X electrode. The second transparent conductive 1b includes a substrate 11b and a transparent conductive film 12b provided on the surface of the substrate 11b. The transparent conductive film 12b is patterned and forms a Y electrode.

The X electrode extends in the X-axis direction (first direction) in the surface of the substrate 11a, whereas the Y electrode extends in the Y-axis direction (second direction) in the surface of the substrate 11b. Therefore, the X electrode and the Y electrode intersect at right angles.

The X electrode made from the transparent conductive film 12a includes a plurality of pads (first unit electrodes) 42a and a plurality of connectors (first connectors) 42b which connect the plurality of pads 42a to each other. The connector 42b extends in the X-axis direction and connects the ends of the adjacent pads 42a to each other. The pad 42a and the connector 42b are integrated.

The Y electrode made from the transparent conductive film 12b includes a plurality of pads (second unit electrodes) 43a and a plurality of connectors (second connectors) 43b which connect the plurality of pads 43a to each other. The connector 43b extends in the Y-axis direction and connects the ends of the adjacent pads 43a to each other. The pad 43a and the connector 43b are integrally formed.

As viewing the information input device 2 from the touch screen side, the X electrode and the Y electrode preferably have a configuration where the pads 42a and the pads 43a are closely arranged over one main surface of the information input device 2 without overlapping with each other. This is because this configuration can make the reflectance in the touch screen of the information input device 2 substantially the same.

Although the shape of the X electrode and the Y electrode where a plurality of pads (unit electrodes) 42a and 43a having a predetermined shape are linearly connected is described here, the shape of the X electrode and the Y electrode is not limited to this example. For example, the X electrode and the Y electrode can also have a stripe shape (linear shape).

The first transparent conductive element 1a and the second transparent conductive element 1b are the same as the transparent conductive element 1 according to the second embodiment except the above points.

### [Effect]

In the information input device 2 according to the fifth embodiment, the transparent conductive film 12 which prevents diffuse reflection of light as described in the second embodiment is used as the X electrode and the Y electrode. This can prevent the patterned X electrode and Y electrode from being visible by diffuse reflection of outside light. The disposition of the information input device 2 over the display screen of the display device 3 allows black display without milky appearance (whitish appearance) which is caused by diffuse reflection of outside light in the X electrode and the Y electrode provided in the information input device 2.

The present technique is not limited to the information input device 2 having the above configuration and can be widely applied to information input devices including the transparent conductive film 12, for example, resistive touch panels. This configuration even provides the same effect as the information input device 2 according to the fifth embodiment.

### [Modifications]

### (Modification 1)

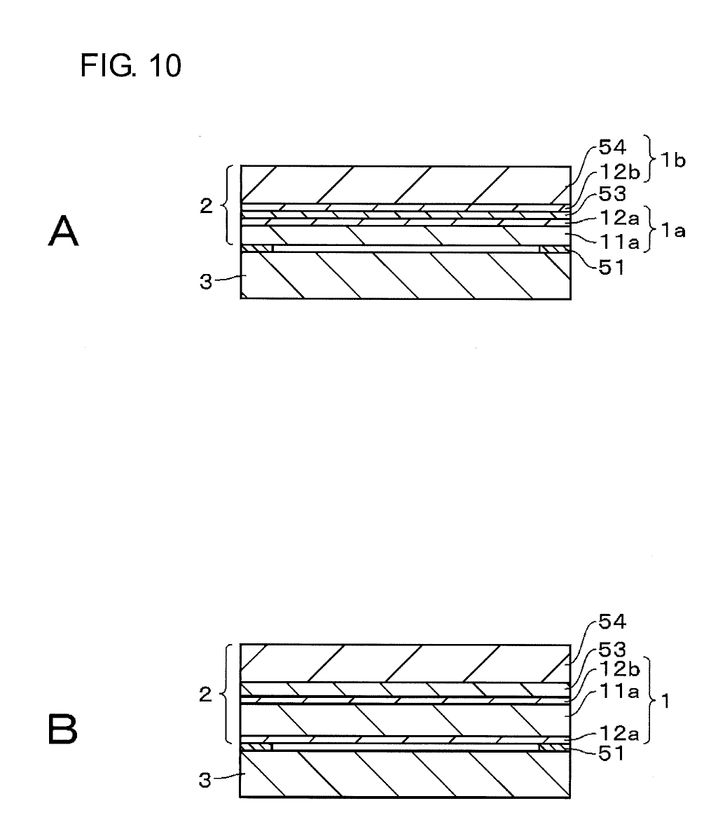

The cross-sectional diagram A of FIG. 10 illustrates an example of a configuration of an information input device according to a first modification. A first transparent conductive element 1a includes a substrate 11a and a transparent conductive film 12a provided on the surface of the substrate 11a. A second transparent conductive element 1b includes a protective layer 54 and a transparent conductive film 12b provided on the back side of the protective layer 54. The first transparent conductive element 1a and the second transparent conductive element 1b are attached to each other so that the respective transparent conductive films 12a and 12b face each other through the bonding layer 53.

### (Modification 2)

The cross-sectional diagram B of FIG. 10 illustrates an example of a configuration of an information input device according to a second modification. A transparent conductive element 1 includes a substrate 11a, a transparent conductive film 12a provided on the back side of the substrate 11a, and a transparent conductive film 12b provided on the surface of the substrate 11a. The transparent conductive element 1 and a protective layer 54 are attached to each other through a bonding layer 53.

### (Modification 3)

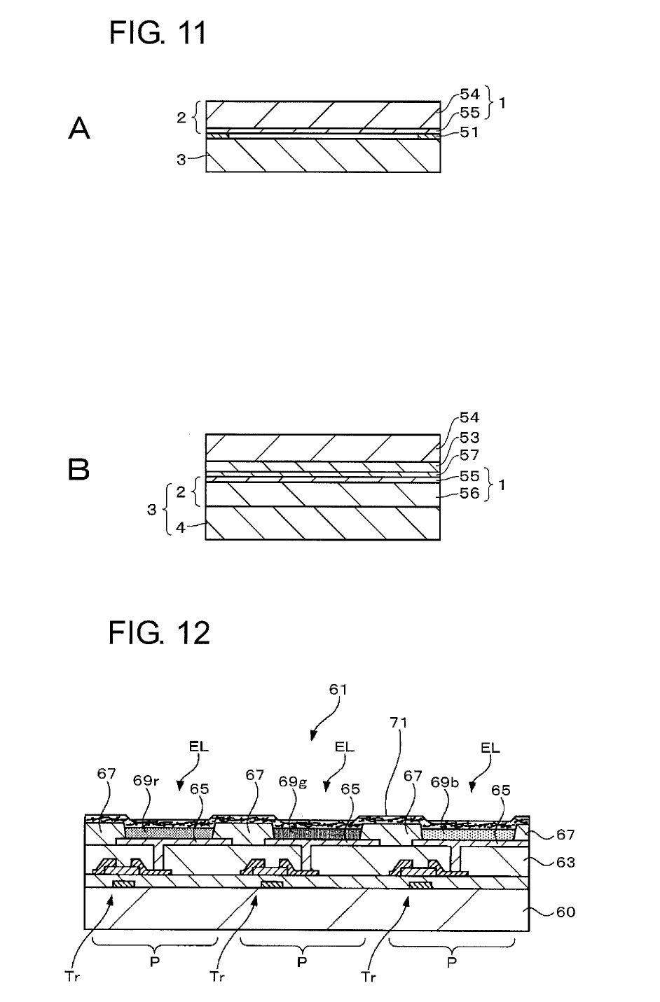

The cross-sectional diagram A of FIG. 11 illustrates an example of a configuration of an information input device according to a third modification. A transparent conductive element 1 includes a protective layer 54 and an electrode pattern part 55 directly provided on the back side of the protective layer 54. The electrode pattern part 55 includes an X electrode transparent conductive film and a Y electrode transparent conductive film. These transparent conductive films are directly formed on the back side of the protective layer 54. The X electrode transparent conductive film and the Y electrode transparent conductive film may be laminated through an insulating layer.

### (Modification 4)

The cross-sectional diagram B of FIG. 11 illustrates an example of a configuration of a display device according to a fourth modification. A display device 3 includes a display panel unit 4 such as a liquid crystal panel, a cover layer 56 such as a cover glass provided on the surface of the display panel unit 4, an electrode pattern part 55 provided on the surface of the cover layer 56, and a polarizer 57 provided on the surface of the electrode pattern part 55. A protective layer 54 is provided on the surface of the polarizer 57 through a bonding layer 53. The electrode pattern part 55 includes an X electrode transparent conductive film and a Y electrode transparent conductive film. These transparent conductive films may be directly formed on the surface of the cover layer 56. The X electrode transparent conductive film and the Y electrode transparent conductive film may be laminated through an insulating layer.

### 6. Sixth Embodiment

FIG. 12 illustrates a cross-sectional diagram of the main part of a display device using the transparent conductive film. A display device 61 illustrated in this figure is an active-matrix organic EL display device having an organic electroluminescence element EL.

As illustrated in FIG. 12, the display device 61 is an active-matrix type in which a pixel circuit having a thin-film transistor Tr and an organic electroluminescence element EL in connection with the pixel circuit are arranged in each pixel P over the substrate 60.

The substrate 60 having an array of thin film transistors Tr is covered with a flat insulating film 63. Over the flat insulating film 63, pixel electrodes 65 which are in connection with the thin film transistors Tr through connection holes provided in the flat insulating film 63 are arranged. The pixel electrodes 65 form anodes (or cathodes).

The pixel electrodes 65 are separated from each other so that the peripheries of the pixel electrodes 65 are covered with window insulation layers 67, respectively. The separated pixel electrodes 65 are covered with organic luminescence function layers 69r, 69 g, and 69b having different colors, respectively, and furthermore these layers are covered with a common electrode 71. The organic luminescence function layers 69r, 69 g, and 69b each have a laminated structure including at least an organic light emitting layer. In the common electrode 71 covering these layers, a layer in contact with the organic luminescence function layers 69r, 69 g, and 69b is formed, for example, as a cathode (or an anode). The common electrode 71 is generally formed as an optically transparent electrode which extracts light emitted from the organic luminescence function layers 69r, 69 g, and 69b. The transparent conductive film 12 according to the second embodiment is used for at least part of the layer of the common electrode 71.

As described above, the organic electroluminescence element EL is formed in each pixel P part in which the organic luminescence function layers 69r, 69 g, or 69b is sandwiched between the pixel electrode 65 and the common electrode 71. Although not illustrated in the figure, a protective layer is further provided over the substrate 60 having these organic electroluminescence elements EL, and a sealing substrate is attached to the protective layer through an adhesive to form the display device 61.

### [Effect]

The display device 61 of the sixth embodiment described above includes the transparent conductive film 12 according to the second embodiment as the common electrode 71 provided at the display screen side from which emitted light is extracted. This prevents milky appearance (whitish appearance) caused by diffuse reflection of outside light in the common electrode 71 when light emitted from the organic luminescence function layers 69r, 69 g, and 69b is extracted from the common electrode 71 side, enabling display with high contrast even under outside light environment.

At the display screen side of the display device 61, an information input device 2 may be disposed in the same manner as in the fifth embodiment. Even in this case, the same effect as in the fifth embodiment can be obtained.

### 7. Seventh Embodiment

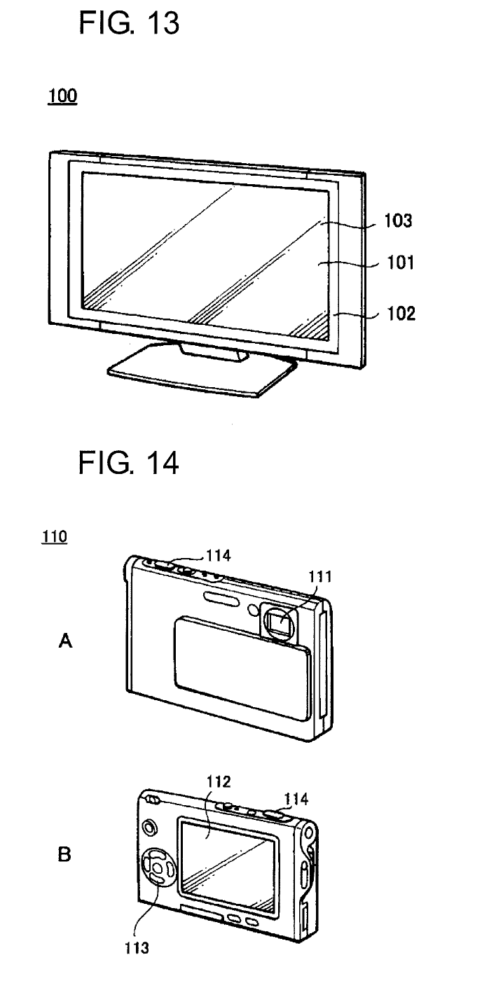

FIGS. 13 to 17 illustrate examples of electronic instruments in which a display device including the information input device according to the fifth embodiment or the display device according to the sixth embodiment is used as a display unit. Hereinafter, application of the electronic instrument according to the present technique will be described.

FIG. 13 is a perspective view of a television set to which the present technique is applied. A television set 100 according to this application includes a display unit 101 including a front panel 102 and a filter glass 103. The display device described above is used as the display unit 101.

FIG. 14 illustrates a digital camera to which the present technique is applied, where FIG. 14A is a perspective view from the front side and FIG. 14B is a perspective view from the back side. The digital camera 110 according to this application includes a flash light-emitting unit 111, a display unit 112, a menu switch 113, and a shutter button 114, and the display device described above is used as the display unit 112.

FIG. 15 is a perspective view of a laptop personal computer to which the present technique is applied. A laptop personal computer 120 according to this application includes a body 121, a keyboard 122 used for inputting letters or the like, and a display unit 123 which displays images or the like. The display device described above is used as the display unit 123.

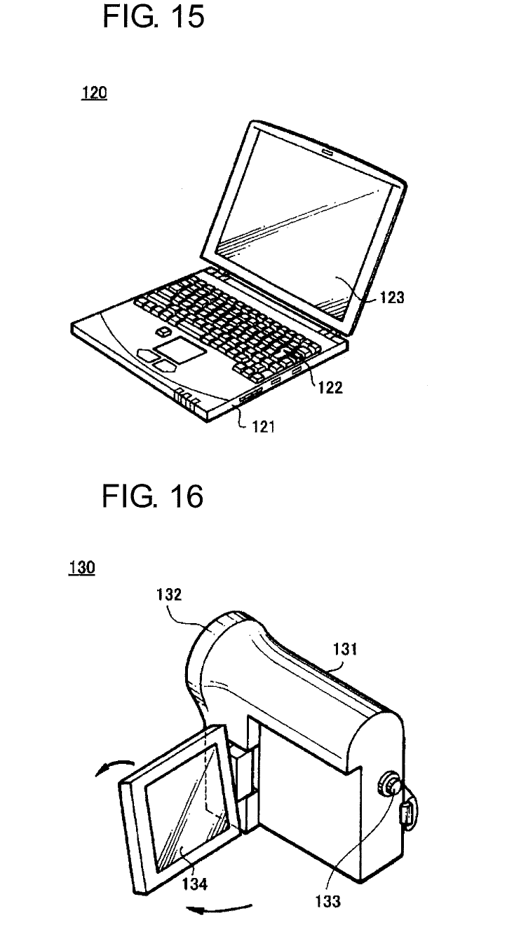

FIG. 16 is a perspective view of a video camera to which the present technique is applied. A video camera 130 according to this application includes a body 131, a lens 132 for photographing subjects at the side facing front, a start/stop switch 133 for photographing, and a display unit 134. The display device described above is used as the display unit 134.

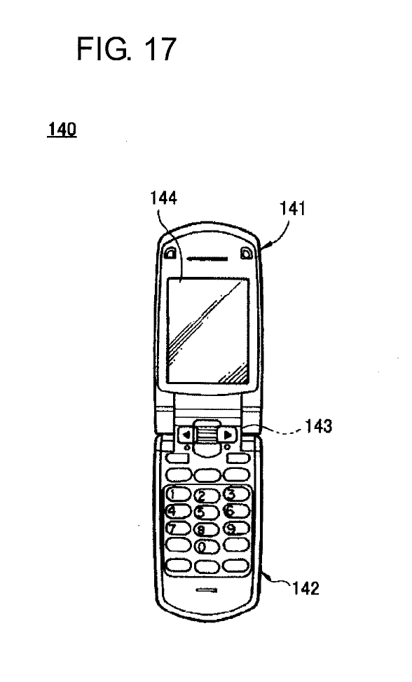

FIG. 17 is a front view of a mobile terminal to which the present technique is applied, for example, a mobile phone. A mobile phone 140 according to this application includes an upper casing 141, a lower casing 142, a connector (hinge in this case) 143, and a display unit 144. The display device described above is used as the display unit 144.

Even the above electronic instruments enable display with high contrast even under outside light environment by using the display device 3 according to the fifth embodiment or the display device 61 according to the sixth embodiment as the display unit.

### EXAMPLES

The present technique will be described below in detail by way of Examples, but the present technique is not limited only to these Examples.

The procedure of the third embodiment described above was applied to produce transparent conductive films of Examples 1 to 10 and Comparative Examples 1 to 18 in the following manner (see Tables 1 to 4 below).

### Examples 1 to 10

First, a silver nanowire was produced as a metal nanowire. In this case, a silver nanowire having a diameter of 30 nm and a length of 10 to 30 μm was produced according to a known method with reference to the literature (“ACS Nano” 2010, vol. 4, No. 5, pp. 2955-2963.)

Next, the silver nanowire was placed together with the following materials in ethanol, and the silver nanowire was dispersed in ethanol using sonication to produce a dispersion.

Silver nanowire: 0.28% by mass
Ethyl cellulose (49% ethoxy) produced by Wako Pure
Chemical Industries, Ltd. (transparent resin material): 0.83% by mass
Duranate D101 produced by Asahi Kasei Corporation (resin curing agent): 0.083% by mass
NEOSTANN U-100 produced by Nitto Chemical Co., Ltd. (curing-accelerating catalyst): 0.0025% by mass
IPA (solvent): 98.8045% by mass

The produced dispersion was applied to a transparent substrate with a No. 8 coil bar to form a dispersion film. The basis weight of the silver nanowire was about 0.036 g/m² or more, so that the sheet resistance of the transparent conductive film to be finally obtained was about 100Ω/□. As the transparent substrate, PET having a thickness of 125 μm (produced by Toray Industries, Inc., Trade name: U34) was used. Next, the transparent substrate was heated at 120° C. for 30 minutes in an oven and the solvent in the dispersion film was removed by drying. Furthermore, in order to increase the points of contact and the contact area between the silver nanowires, the transparent substrate was pressed with a calender at a linear pressure of 1000 N/4 cm and a line speed of 21 cm/min. Subsequently, the transparent substrate was heated at 150° C. for 30 minutes in the atmosphere to cure the transparent resin material in the dispersion film to provide the dispersion film of the silver nanowire.

Next, the following treatment was carried out in order to improve the contrast of the dispersion film of the silver nanowire produced as described above.

The amine-terminated thiol, 11-amino-1-undecanethiol hydrochloride or 16-amino-1-hexadecanethiol hydrochloride (all produced by Dojindo Laboratories), was dissolved in an amount of 0.25% by mass in ethanol, dimethyl sulfoxide, or acetone. In this solution, the produced dispersion film of the silver nanowire was immersed at room temperature for 2 hours to form a self-assembled film, so that the amine-terminated thiol in the solution was adsorbed to the silver nanowire in the dispersion film.

Next, the chromophoric dyes shown in Table 1 were used in the form of the acid chlorides and each acid chloride was dissolved in an amount of 0.25% by mass in dimethyl sulfoxide. In this solution, the dispersion film of the silver nanowire with the amine-terminated thiol being adsorbed thereto was immersed at room temperature (immersion time: 1 second). The COCl group of the dye in the solution was reacted with the amine in the dispersion film to produce a transparent conductive film in which the colored self-assembled film was adsorbed to the silver nanowire.

A protective layer was formed over the surface of the obtained transparent conductive film in the following manner. An ultraviolet curable resin (produced by TESK Co., Ltd., Trade name: A2398B) was dissolved in IPA in an amount of 0.1% by mass based on the solid content. This solution was applied at a wet thickness of 116 μm to the transparent conductive film with an applicator, followed by drying for 2 minutes in an oven at 80° C. and subsequent ultraviolet irradiation at an integrated light amount of 300 mJ/cm², to form as a protective layer an acrylic layer curable by ultraviolet rays of about 100 nm.

### Comparative Example 1

In Comparative Example 1, a transparent conductive film including a protective layer was obtained in the same manner as in Example 1 except that the adsorption treatment of the thiols and the reaction process between the thiols and the dyes in Example 1 were not carried out.

### Comparative Examples 2 to 6

In Comparative Examples 2 to 6, transparent conductive films including a protective layer were obtained in the same manner as in Example 1 except that the adsorption treatment of the thiols was not carried out, the dyes described in Table 1 were used without being made into the acid chlorides, and the dye-adsorption conditions were 10 minutes at 80° C.

### Comparative Example 7

In Comparative Example 7, a transparent conductive film including a protective layer was obtained in the same manner as in Example 1 except that the reaction treatment between the thiols and the dyes was not carried out.

### Comparative Examples 8 to 12

In Comparative Examples 8 to 12, transparent conductive films including a protective layer were obtained in the same manner as in Example 1 except that the dyes described in Table 1 were used without being made into the acid chlorides and the dye-adsorption conditions were 10 minutes at 80° C.

### Comparative Example 13

In Comparative Example 13, a transparent conductive film including a protective layer was obtained in the same manner as in Example 1 except that a self-assembled film was formed using the thiols described in Table 1 and the reaction treatment between the thiols and the dyes was not carried out.

### Comparative Examples 14 to 18

In Comparative Examples 14 to 18, transparent conductive films including a protective layer were obtained in the same manner as in Example 1 except that a self-assembled film was formed using the thiols described in Table 1 and the dyes described in Table 1 were used without being made into the acid chlorides, and the dye-adsorption conditions were 10 minutes at 80° C.

The transparent conductive films produced in Examples 1 to 10 and Comparative Examples 1 to 18 were evaluated for A) total light transmittance [%], B) HAZE, C) milky appearance (whitish appearance), D) sheet resistance [Ω/□], and E) reflectance L value. Each evaluation was carried out as follows.

### <A) Evaluation of Total Light Transmittance>

The total light transmittance was evaluated using a haze meter (produced by Murakami Color Research Laboratory. Co., Ltd., Trade name: HM-150) according to JIS K7361.

### <B) Evaluation of HAZE>

The haze was evaluated using a haze meter (produced by Murakami Color Research Laboratory. Co., Ltd., Trade name: HM-150) according to JIS K7136.

### <C) Evaluation of Milky Appearance (Whitish Appearance)>

Except Comparative Example 1, part without being treated by adsorption (untreated part) was formed in the vicinity of part treated by adsorption (treated part). The transparent conductive films were visually observed from the transparent substrate side while a black tape was pasted on the dispersion film (wire layer) side on which the treated part and the untreated part were formed. The occurrence of the milky appearance (whitish appearance) was evaluated in the following three levels; A, B, and C.

A: The boundary line between the treated part and the non-treated part was easily recognized, and the milky appearance (whitish appearance) in the treated part was reduced.
B: The boundary line between the treated part and the non-treated part was difficult to recognize, but the milky appearance (whitish appearance) in the treated part was reduced.
C: The boundary line between the treated part and the non-treated part was not recognized, and the milky appearance (whitish appearance) in the treated part was observed. It is noted that Comparative Example 1 is the same as the untreated parts other than Comparative Example 1. That is, the three-level evaluation except for Comparative Example 1 was based on Comparative Example 1.

### <D) Evaluation of Sheet Resistance>

The sheet resistance was evaluated by bringing a measuring probe into contact with the dispersion film (wire layer) side using a non-destructive resistance measuring device (produced by Napson corporation, Trade name: EC-80P).

### <E) Evaluation of Reflectance L Value>

For the reflectance L value, the samples used in the evaluation of the milky appearance (whitish appearance) were used and the spectral reflectance was measured with Color i5 produced by X-Rite, Incorporated according to JIS 28722 to obtain the L* value of the L*a*b*color system.

### (Conditions)

Table 1 shows the production conditions of the transparent conductive films of Examples 1 to 10; and Table 2 shows the production conditions of the transparent conductive films of Comparative Examples 1 to 18.

TABLE 1

| | Thiols and/or sulfides | | Dye and/or dye compound | | | |
|---|---|---|---|---|---|---|
| | | Adsorption treatment | | | Acid chloride | Adsorption treatment |
| | Material | conditions | Material | Chromophore | synthesis | conditions |
| Example 1 | 11-amino-1- | Room temperature | 3-ferrocenoyl | Ferrocene | Yes | RT for 1 s |
| | undecanethiol | (RT) for 2 hrs | propionic acid | | | |
| Example 2 | | | 1,1′-ferrocene | Ferrocene | Yes | RT for 1 s |
| | | | dicarboxylic acid | | | |
| Example 3 | | | NK-5778 | Cyanine | Yes | RT for 1 s |
| Example 4 | | | NK-8990 | Cyanine | Yes | RT for 1 s |
| Example 5 | | | LA1920 | Triphenylmethane | Yes | RT for 1 s |
| Example 6 | 16-amino-1- | RT for 2 hrs | 3-ferrocenoyl | Ferrocene | Yes | RT for 1 s |
| | hexadecanethiol | | propionic acid | | | |
| Example 7 | | | 1,1′-ferrocene | Ferrocene | Yes | RT for 1 s |
| | | | dicarboxylic acid | | | |
| Example 8 | | | NK-5778 | Cyanine | Yes | RT for 1 s |
| Example 9 | | | NK-8990 | Cyanine | Yes | RT for 1 s |
| Example 10 | | | LA1920 | Triphenylmethane | Yes | RT for 1 s |

TABLE 2

| | Thiols and/or sulfides | | Dye and/or dye compound | | | |
|---|---|---|---|---|---|---|
| | | Adsorption treatment | | | Acid chloride | Adsorption treatment |
| | Material | conditions | Material | Chromophore | synthesis | conditions |
| Comparative | — | — | — | — | No | — |
| Example 1 | | | | | | |
| Comparative | — | — | 3-ferrocenoyl propionic acid | Ferrocene | No | 80° C. 10 min |
| Example 2 | | | | | | |
| Comparative | — | — | 1,1′-ferrocene dicarboxylic | Ferrocene | No | 80° C. 10 min |
| Example 3 | | | acid | | | |
| Comparative | — | — | NK-5778 | Cyanine | No | 80° C. 10 min |
| Example 4 | | | | | | |
| Comparative | — | — | NK-8990 | Cyanine | No | 80° C. 10 min |
| Example 5 | | | | | | |
| Comparative | — | — | LA1920 | Triphenylmethane | No | 80° C. 10 min |
| Example 6 | | | | | | |
| Comparative | 11-amino-1- | Room temperature | — | — | No | — |
| Example 7 | undecanethiol | (RT) for 2 hrs | | | | |
| Comparative | | | 3-ferrocenoyl propionic acid | Ferrocene | No | 80° C. 10 min |
| Example 8 | | | | | | |
| Comparative | | | 1,1′-ferrocene dicarboxylic | Ferrocene | No | 80° C. 10 min |
| Example 9 | | | acid | | | |
| Comparative | | | NK-5778 | Cyanine | No | 80° C. 10 min |
| Example 10 | | | | | | |
| Comparative | | | NK-8990 | Cyanine | No | 80° C. 10 min |
| Example 11 | | | | | | |
| Comparative | | | LA1920 | Triphenylmethane | No | 80° C. 10 min |
| Example 12 | | | | | | |
| Comparative | 16-amino-1- | RT for 2 hrs | — | — | No | — |
| Example 13 | hexadecanethiol | | | | | |
| Comparative | | | 3-ferrocenoyl propionic acid | Ferrocene | No | 80° C. 10 min |
| Example 14 | | | | | | |
| Comparative | | | 1,1′-ferrocene dicarboxylic | Ferrocene | No | 80° C. 10 min |
| Example 15 | | | acid | | | |
| Comparative | | | NK-5778 | Cyanine | No | 80° C. 10 min |
| Example 16 | | | | | | |
| Comparative | | | NK-8990 | Cyanine | No | 80° C. 10 min |
| Example 17 | | | | | | |
| Comparative | | | LA1920 | Triphenylmethane | No | 80° C. 10 min |
| Example 18 | | | | | | |

### (NOTE in Tables 1 and 2)

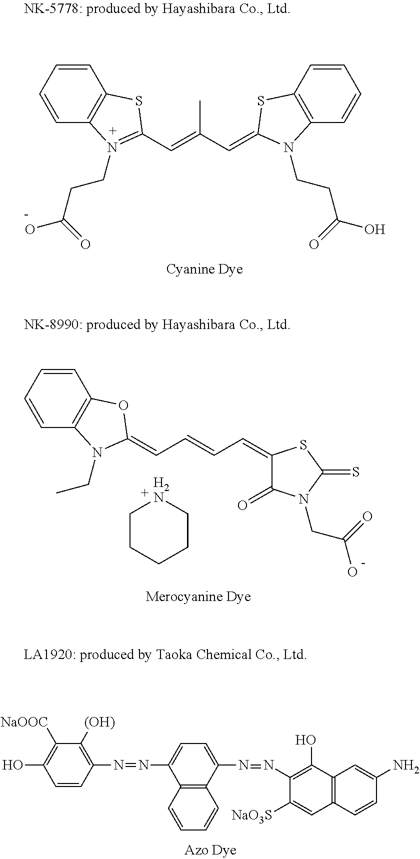

In Tables 1 and 2, the mark “Yes” in the column of “acid chloride synthesis” means that the dye was used in the form of the acid chloride, and the mark “No” means that the dye was used without being made into the acid chloride.

### (Results)

Table 3 shows the evaluation results of the transparent conductive films of Examples 1 to 10, and Table 4 shows the evaluation results of the transparent conductive films of Comparative Examples 1 to 18.

TABLE 3

| | | | Milky | Sheet | |
|---|---|---|---|---|---|
| | Total light | | appearance | resis- | Reflec- |
| | transmit- | HAZE | (whitish | tance | tance |
| | tance (%) | (%) | appearance) | [Ω/□] | L |
| Example 1 | 90.7 | 0.7 | A | 100 | 8.1 |
| Example 2 | 90.6 | 0.8 | A | 100 | 8.2 |
| Example 3 | 90.7 | 0.7 | A | 100 | 7.9 |
| Example 4 | 90.7 | 0.7 | A | 100 | 8 |
| Example 5 | 90.7 | 0.7 | A | 100 | 8 |
| Example 6 | 90.7 | 0.7 | A | 100 | 8.1 |
| Example 7 | 90.7 | 0.8 | A | 100 | 8.1 |
| Example 8 | 90.7 | 0.7 | A | 100 | 7.9 |
| Example 9 | 90.7 | 0.8 | A | 100 | 8 |
| Example 10 | 90.7 | 0.7 | A | 100 | 8 |

TABLE 4

| | | | Milky | Sheet | |
|---|---|---|---|---|---|
| | Total light | | appearance | resis- | Reflec- |
| | transmit- | HAZE | (whitish | tance | tance |
| | tance (%) | (%) | appearance) | [Ω/□] | L |
| Comparative | 90.4 | 0.9 | — | 100 | 9.5 |
| Example 1 | | | | | |
| Comparative | 90.7 | 0.7 | A | OVER | 7.5 |
| Example 2 | | | | RANGE | |
| Comparative | 90.5 | 0.9 | B | 185 | 9.1 |
| Example 3 | | | | | |
| Comparative | 89.9 | 1 | C | 139 | 10 |
| Example 4 | | | | | |
| Comparative | 90.5 | 0.8 | B | 319 | 9.1 |
| Example 5 | | | | | |
| Comparative | 90.5 | 0.8 | B | 209 | 8.7 |
| Example 6 | | | | | |
| Comparative | 90.4 | 0.9 | C | 100 | 9.4 |
| Example 7 | | | | | |
| Comparative | 90.7 | 0.7 | A | OVER | 8.1 |
| Example 8 | | | | RANGE | |
| Comparative | 90.5 | 0.8 | B | 135 | 9.1 |
| Example 9 | | | | | |
| Comparative | 89.8 | 1.1 | C | 118 | 10.1 |
| Example 10 | | | | | |
| Comparative | 90.5 | 0.8 | B | 248 | 9.1 |
| Example 11 | | | | | |
| Comparative | 90.5 | 0.8 | B | 137 | 8.8 |
| Example 12 | | | | | |
| Comparative | 90.4 | 0.9 | C | 100 | 9.4 |
| Example 13 | | | | | |
| Comparative | 90.7 | 0.7 | A | OVER | 7.8 |
| Example 14 | | | | RANGE | |
| Comparative | 90.5 | 0.8 | B | 118 | 9.1 |
| Example 15 | | | | | |
| Comparative | 89.9 | 1 | C | 112 | 10 |
| Example 16 | | | | | |
| Comparative | 90.5 | 0.8 | B | 193 | 8.7 |
| Example 17 | | | | | |
| Comparative | 90.5 | 0.8 | B | 123 | 9 |
| Example 18 | | | | | |

### (Results)

In Examples of the present invention, the thiol compound which constitutes the self-assembled film was reacted with the acid chloride of the dye so that the colored self-assembled film was formed on the silver nanowire, thereby producing a silver nanowire film having no milky appearance (whitish appearance) and very low sheet resistance. The silver nanowire films of Examples enable display with high contrast because of the lack of milky appearance (whitish appearance).

### (Discussion)

An amine, which is the terminal functional group of the self-assembled film, reacts with the carboxylic acid chloride of the dye compound to form an amide bond, so that the dye is bound to the top end of the self-assembled film to improve the contrast.

### Example 11

A photosensitive resin was used as the resin material to produce a transparent conductive element having a patterned transparent conductive film in the following manner.

First, silver nanowire [1] having a diameter of 30 nm and a length of 10 μm was produced in the same manner as in Example 1.

Next, a dispersion of silver nanowire [1] was prepared from the produced silver nanowire [1] and the following materials.

Silver nanowire [1]: 0.11% by mass

Photosensitive group-azido-containing polymer (average weight molecular weight: 100,000) produced by Toyo Gosei Co., Ltd.: 0.272% by mass

Colored self-assembled material (reaction product between Lanyl Black BG E/C produced by Okamoto Dyestuff Co., Ltd. and 2-aminoethane thiol produced by Tokyo Chemical Industry Co., Ltd.): 0.03% by mass

Water: 89.615% by mass

Ethanol: 10% by mass

The prepared dispersion was applied to a transparent substrate with a No. 8 coil bar to form a dispersion film. The basis weight of the silver nanowire was about 0.02 g/m². As the transparent substrate, PET having a thickness of 100 μm (Lumirror®U34 produced by Toray Industries, Inc.) was used.

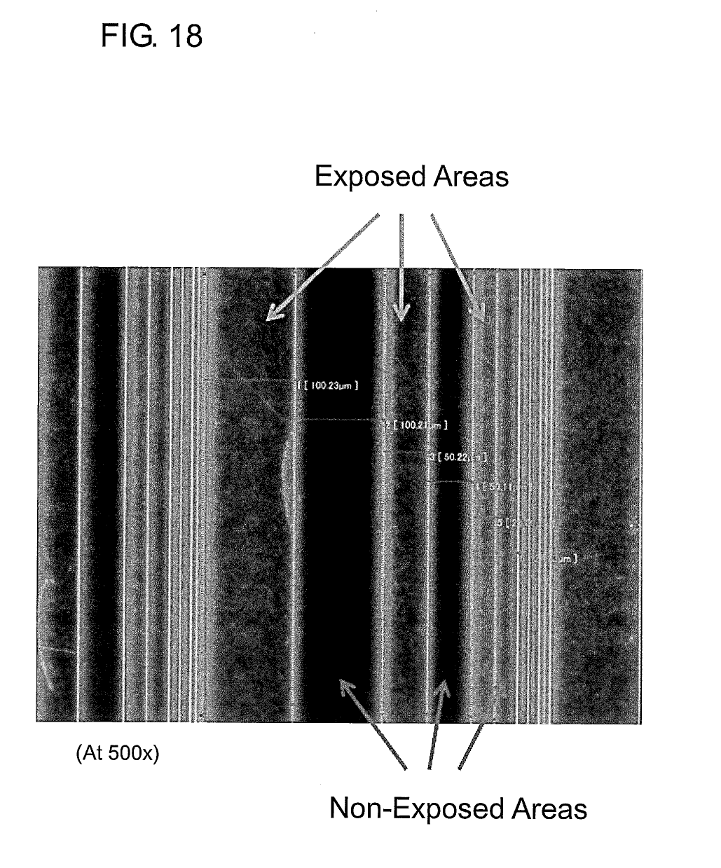

Next, the transparent substrate was heated at 80° C. for 3 minutes in the atmosphere and the solvent in the dispersion film was removed by drying. The coating film was brought into soft contact with a photomask (see FIG. 18) and irradiated with ultraviolet rays at an integrated light amount of 10 mJ using an alignment exposure device produced by Toshiba Lighting & Technology Corporation to cure exposed areas.

Next, 100 mL of a 20% by mass acetic acid solution was showered on the coating film to remove non-exposed areas, followed by development. Subsequently, calendering (nip width: 1 mm, load: 4 kN, rate: 1 m/min) was performed.

### Examples 12, 13

A transparent conductive element was produced in the same procedure as in Example 11 except that DEN produced by Shinko Corporation (Example 12) or LA1920 produced by Taoka Chemical Co., Ltd. (Example 13) was used as a colored compound, instead of Lanyl Black BG E/C produced by Okamoto Dyestuff Co., Ltd.

### Examples 14, 15

A transparent conductive element was produced in the same procedure as in Example 11 except that the integrated light amount of irradiation was changed into 1 mJ or 5000 mJ.

### Example 16

A transparent conductive element was produced in the same procedure as in Example 11 except that a photosensitive group-azido-containing polymer (average weight molecular weight: 25,000) produced by Toyo Gosei Co., Ltd. was used instead of the photosensitive group-azido-containing polymer (average weight molecular weight: 100,000) produced by Toyo Gosei Co., Ltd. which was used in Example 11.

### Example 17

A dispersion of a silver nanowire was prepared from the same silver nanowire [1] as in Example 1 and the following materials.

Silver nanowire [1]: 0.11% by mass

Functional oligomer (CN9006 produced by Sartomer Company, Inc.): 0.176% by mass

Pentaerythritol triacrylate (triester 37%) (A-TMM-3 produced by Shin-Nakamura Chemical Co., Ltd.): 0.088% by mass

Polymerization initiator (IRGACURE 184 produced by BASF): 0.008% by mass

Colored self-assembled material (reaction product between Lanyl Black BG E/C produced by Okamoto Dyestuff Co., Ltd. and 2-aminoethane thiol produced by Tokyo Chemical Industry Co., Ltd.): 0.03% by mass

IPA: 96.615% by mass

DAA: 3% by mass

A transparent conductive element was produced in the same manner as Example 11 using the prepared dispersion except that the integrated light amount of ultraviolet irradiation was 800 mJ and IPA was used as a developer, instead of the 20 wt % acetic acid solution.

### Comparative Example 19

A dispersion of a silver nanowire was prepared from the same silver nanowire [1] as in Example 1 and the following materials. This dispersion was free of a colored compound.

Silver nanowire [1]: 0.11% by mass

Photosensitive group-azido-containing polymer (average weight molecular weight: 100,000) produced by Toyo Gosei Co., Ltd.: 0.272% by mass

Water: 89.618% by mass

Ethanol: 10% by mass

A transparent conductive element was produced in the same manner as in Example 11 using the prepared dispersion.

### <Evaluation>

The transparent conductive elements obtained in

Examples 11 to 17 and Comparative Example 19 were evaluated for (A) total light transmittance [%], (B) haze value, (C) sheet resistance [Ω/□], and (D) reflectance L value, (E) adhesion, (F) resolution, and (G) invisibility in the following manner. These results are shown in Table 5.

(A) Total light transmittance: evaluated in the same manner as in Example 1.

(B) Haze value: evaluated in the same manner as in Example 1.

(C) Sheet resistance: evaluated using MCP-T360 (Trade name) produced by Mitsubishi Chemical Analytic Co., Ltd.)

(D) Reflectance L value: evaluated in the same manner as in Example 1.

(E) Adhesion: evaluated by the cross-cut (1 mm intervals×100 squares) cellophane tape (CT24 produced by Nichiban Co., Ltd.) peeling test according to JIS K5400.

(F) Resolution: evaluated according to the following evaluation criteria using VHX-1000 produced by KEYENCE CORPORATION in dark field at magnifications from 100× to 1000×.

Evaluation Criteria for Resolution

AA: Five spots in the coating film surface were randomly selected. For all of the selected five points, the error range of the line width of 25 μm in the electrode pattern was within ±10% as compared with the set value of the photomask.

A: The above error range was within ±20%.

C: The above error range exceeded ±20%.

### (G) Invisibility

The transparent conductive element was attached to a 3.5 inch diagonal liquid crystal display so that the transparent conductive film side of the transparent conductive element faced the screen through an adhesive sheet. Next, an AR film was attached to the substrate (PET film) side of the transparent conductive element through an adhesive sheet. Subsequently, the liquid crystal display was allowed to display black, and the display screen was visually observed to evaluate the invisibility according to the following criteria.

Evaluation Criteria of Invisibility

AA: No pattern was recognized at any angle.

A: The pattern was very difficult to recognize but was recognized depending on the angle.

C: The pattern was recognized.

TABLE 5

| | | (A) Total light | | | (D) | | | |
|---|---|---|---|---|---|---|---|---|
| | | transmittance | (B) Haze value | (C) Sheet | Reflectance | | | |
| | Colored compound | (%) | (%) | resistance (Ω/□) | L value | (E) Adhesion | (F) Resolution | (G) Invisibility |
| Example 11 | Lany Black BG E/C | 91.2 | 0.8 | 100 | 7.8 | 100/100 | AA | AA |
| Example 12 | DEN | 90.8 | 1 | 100 | 8.7 | 100/100 | AA | A |
| Example 13 | LA1920 | 90.9 | 0.9 | 100 | 8.4 | 100/100 | AA | AA |
| Example 14 | Lany Black BG E/C | 91.2 | 0.8 | 100 | 8 | 100/100 | AA | AA |
| Example 15 | Lany Black BG E/C | 91 | 0.8 | 100 | 8 | 100/100 | A | AA |
| Example 16 | Lany Black BG E/C | 91.3 | 0.8 | 100 | 8 | 100/100 | AA | AA |
| Example 17 | Lany Black BG E/C | 90.6 | 0.8 | 100 | 8 | 100/100 | A | AA |
| Comparative | None | 90.4 | 1 | 100 | 8.8 | 100/100 | AA | C |
| Example 19 | | | | | | | | |

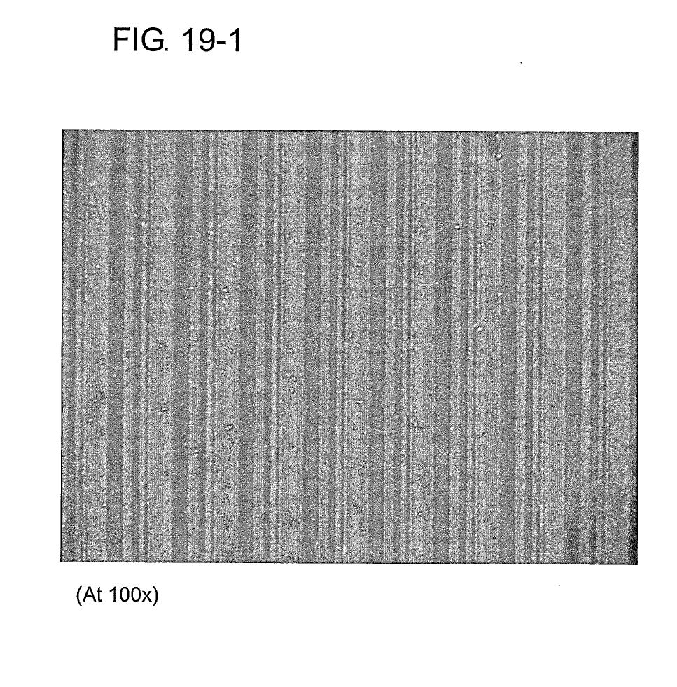

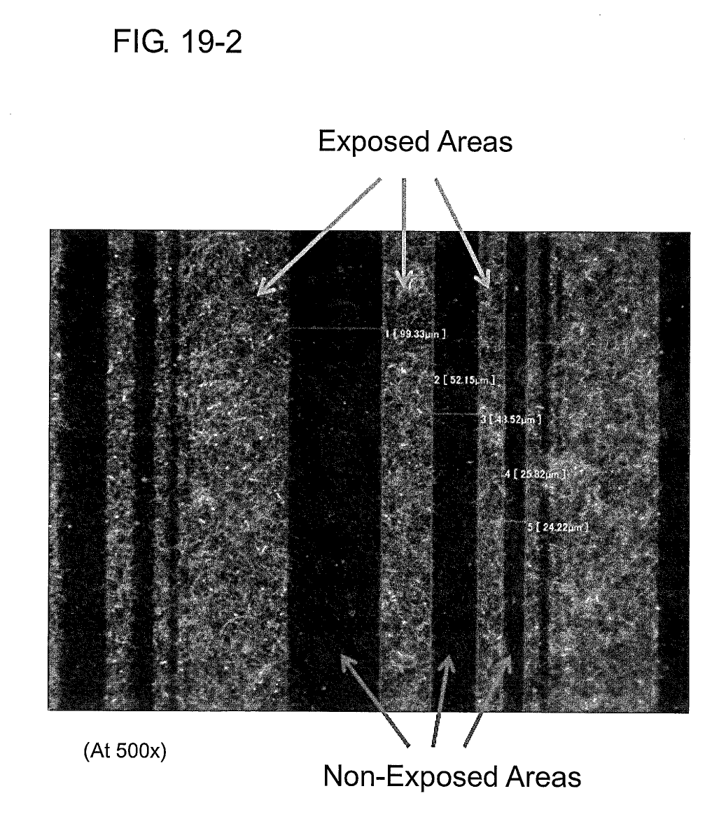

As shown from Table 5, the development properties as well as the visibilities were favorable in Examples 11 to 17. FIGS. 19-1 and 19-2 illustrate the optical microscope images of Example 11 as typical examples. As shown in FIGS. 19-1 and 19-2, the measured value of the electrode pattern with a line width of 25 μm falls within ±10% of the error range in Example 11. The resolution in Examples 15 and 17 is lower than that in Examples 11 to 14, and 16. This may be because that light slightly leaked to the non-exposed areas or the reactions propagated to the non-exposed areas during the light irradiation at an integrated light amount of 5000 mJ in Example 15, and the reactions propagated to the non-exposed areas in Example 17.

Although the embodiments and Examples of the present technique are specifically described above, the present technique is not limited to the above embodiments and Examples, and various modifications based on the technical idea of the present technique can be made.

For example, the configurations, the methods, the procedures, the shapes, the materials, the numerical values, and the like in the above embodiments and Examples are illustrative only, and different configurations, methods, procedures, shapes, materials, numerical values, and the like can be used as needed.

Furthermore, the configurations, the methods, the procedures, the shapes, the materials, the numerical values, and the like in the above embodiments and Examples can be combined to each other without departing from the spirit of the present technique. For example, two or more of modifications 1 to 8 in the first embodiment can be combined for use.

Although the configuration where the transparent conductive film is provided on the surface of the substrate is illustrated in the above embodiments and Examples, the transparent conductive film may be used singly without the substrate.

### REFERENCE SIGNS LIST

1, 1₁, 1₂ . . . transparent conductive element
11 . . . substrate
12 . . . transparent conductive film
21 . . . metal filler
22 . . . resin material
23 . . . colored self-assembled material
23a . . . self-assembled material
23b . . . colored material
25 . . . dispersant
31 . . . overcoat layer
32 . . . anchor layer
33, 34 . . . hard coat layer
35, 36 . . . anti-reflection layer

1. A transparent conductive film comprising:
a metal filler; and
a colored self-assembled material provided on a surface of the metal filler.

2. The transparent conductive film according to claim 1, wherein the colored self-assembled material is adsorbed to the surface of the metal filler.

3. The transparent conductive film according to claim 1, wherein the colored self-assembled material absorbs light in a visible light range.

4. The transparent conductive film according to claim 1, wherein the colored self-assembled material is formed by binding a self-assembled material to a colored material.

5. The transparent conductive film according to claim 4, wherein the colored material is a dye.

6. The transparent conductive film according to claim 4, wherein the colored material has a chromophore absorbing light in a visible light range and a group to be bound to the self-assembled material.

7. The transparent conductive film according to claim 4, wherein the colored material is an acid halide.

8. The transparent conductive film according to claim 4, wherein the colored material is represented by the following general formulas,
R—COX,
R—SO₃H, or
R—SO₃⁻Na⁺
wherein R is a chromophore absorbing light in a visible light range, and X is fluorine (F), chlorine (Cl), bromine (Br), or iodine (I).

9. The transparent conductive film according to claim 6, wherein the chromophore is an organic material or an inorganic material.

10. The transparent conductive film according to claim 7, wherein the acid halide is an acid chloride.

11. The transparent conductive film according to claim 4, wherein the self-assembled material has a group to be adsorbed to the metal filler.

12. The transparent conductive film according to claim 11, wherein the self-assembled material is at least one selected from thiols, dithiols, sulfides, and disulfides.

13. The transparent conductive film according to claim 1, wherein a colored self-assembled monolayer comprising the colored self-assembled material is provided on the surface of the metal filler.

14. The transparent conductive film according to claim 1, wherein the metal filler is a metal nanowire.

15. The transparent conductive film according to claim 1, wherein the metal filler contains at least one selected from Ag, Au, Ni, Cu, Pd, Pt, Rh, Ir, Ru, Os, Fe, Co, and Sn.

16. A composition comprising
a metal filler, and
a colored self-assembled material provided on a surface of the metal filler.

17. A transparent conductive film-forming composition according to claim 16, wherein the colored self-assembled material is adsorbed to the surface of the metal filler.

18. A transparent conductive film-forming composition comprising a metal filler to which a colored self-assembled material is adsorbed and a photosensitive resin.

19. A transparent conductive film-forming composition comprising a metal filler, a colored self-assembled material, and a photosensitive resin.

20. A conductive element comprising:
a substrate; and
a transparent conductive film provided on a surface of the substrate,
wherein the transparent conductive film includes:
a metal filler; and
a colored self-assembled material provided on a surface of the metal filler.

21. The conductive element according to claim 20, wherein the colored self-assembled material is adsorbed to the surface of the metal filler.

22. An input device comprising:
a substrate; and
a transparent conductive film provided on a surface of the substrate,
wherein the transparent conductive film includes:
a metal filler; and
a colored self-assembled material provided on a surface of the metal filler.

23. The input device according to claim 22, wherein the colored self-assembled material is adsorbed to the surface of the metal filler.

24. A display device comprising:
a display unit; and
an input device provided in the display unit or on a surface of the display unit,
wherein the input device includes a substrate and a transparent conductive film provided on a surface of the substrate, and
the transparent conductive film includes:
a metal filler; and
a colored self-assembled material provided on a surface of the metal filler.

25. The display device according to claim 24, wherein the colored self-assembled material is adsorbed to the surface of the metal filler.

26. An electronic instrument comprising:
a display unit; and
an input device provided in the display unit or on a surface of the display unit,
wherein the input device includes a substrate and a transparent conductive film provided on a surface of the substrate, and
the transparent conductive film includes:
a metal filler; and
a colored self-assembled material provided on a surface of the metal filler.

27. The electronic instrument according to claim 26, wherein the colored self-assembled material is adsorbed to the surface of the metal filler.
